(19) United States
(12) Patent Application Publication
(10) Pub. No.: US 2008/0125342 A1
(43) Pub. Date: May 29, 2008

(54) FORMULATIONS FOR CLEANING MEMORY DEVICE STRUCTURES

(75) Inventors: Pamela M. Visintin, Red Hook, NY (US); Michael B. Korzenski, Danbury, CT (US)

Correspondence Address: MOORE & VAN ALLEN PLLC, P.O. BOX 13706, Research Triangle Park, NC, 27709, US

(73) Assignee: Advanced Technology Materials, Inc., Danbury, CT (US)

(21) Appl. No.: 11/935,838

(22) Filed: Nov. 6, 2007

Related U.S. Application Data
(60) Provisional application No. 60/864,707, filed on Nov. 7, 2006.
(60) Provisional application No. 60/943,711, filed on Jun. 13, 2007.

(51) Int. Cl. C11D 3/02; C11D 3/08; C11D 3/06; C11D 3/28; C11D 3/43; C11D 1/00

(52) U.S. Cl. 510/175

(57) ABSTRACT

A removal composition and process for removing silicon-containing layers from a microelectronic device having said layers thereon. The removal composition selectively removes layers including, but not limited to, silicon oxide, plasma enhanced tetraethyl orthosilicate (P-TEOS), borophosphosilicate glass (BPSG), plasma enhanced oxide (PEOX), high density plasma oxide (HDP), phosphosilicate glass (PSG), spin-on-dielectrics (SOD), thermal oxide, updoped silicate glass, sacrificial oxides, silicon-containing organic polymers, silicon-containing hybrid organic/inorganic materials, organosilicate glass (OSG), TEOS, fluorinated silicate glass (FSG), hemispherical grain (HSQ), carbon-doped oxide (CDO) glass, and combinations thereof, relative to lower electrode, device substrate, and/or etch stop layer materials.

### FIELD OF THE INVENTION

The present invention relates to compositions for removing silicon-containing insulating layers from microelectronic devices, including vertical memory device structures, having same thereon.

### DESCRIPTION OF THE RELATED ART

The semiconductor industry is driving toward smaller chip geometries and faster and more power-efficient memory devices. Advances in semiconductor processing and device design have resulted in chips with millions of circuit elements and interconnects. Today, memory devices implement hundreds of megabits of storage in a single integrated circuit. Such devices include volatile memory (e.g., dynamic random access memory (DRAM) and static random access memory (SRAM)), non-volatile memory (e.g., electrically erasable programmable read only memory (EEPROM), flash EEPROM, shallow trench isolation (STI), ferroelectric RAM and phase-change RAM), and combinations thereof. Memory performance is becoming increasingly important in determining the overall performance of a system.

Dynamic random access memory (DRAM) circuits (devices) are used extensively in the electronics industry, and more particularly in the computer industry for storing data in binary form (1s and 0s) as charge on a storage capacitor. These DRAM devices are made on semiconductor substrates (or wafers) and then the substrates are diced to form the individual DRAM circuits (or chips). Each DRAM circuit (chip) consists in part of an array of individual memory cells that store binary data (bits) as electrical charge on the storage capacitors. Further, the information is stored and retrieved from the storage capacitors by means of switching on or off a single access transistor) in each memory cell using peripheral address circuits, while the charge stored on the capacitors is sensed via bit lines and by read/write circuits formed on the peripheral circuits of the DRAM chip.

The access transistor for the DRAM device is usually a field effect transistor (FET), and the single capacitor in each cell is formed either in the semiconductor substrate as a trench capacitor, or is built over the FET in the cell area as a stacked capacitor. To maintain a reasonable DRAM chip size and improved circuit performance, it is necessary to further reduce the area occupied by the individual cells on the DRAM chip, and to move the adjacent capacitors on memory cells closer together. Unfortunately, as the cell size decreases, it becomes increasingly more difficult to fabricate stacked or trench storage capacitors with sufficient capacitance to store the necessary charge to provide an acceptable signal-to-noise level for the read circuits (sense amplifiers) to detect. The reduced charge also requires more frequent refresh cycles that periodically restore the charge on these volatile storage cells. This increase in refresh cycles further reduces the performance (speed) of the DRAM circuit. As cell density increases and cell area decreases, it is also necessary to make the capacitors closer together. This results in increased parasitic capacitance between adjacent capacitors and can disturb the data retention (charge) on the capacitor.

Since the capacitor area is limited to the cell size in order to accommodate the multitude of cells on the DRAM chip, it is necessary to explore alternative methods for increasing the capacitance while decreasing the lateral area that the capacitor occupies on the substrate surface. It is well known in the art that the smaller the thickness of the dielectric layer, the higher the dielectric constant (k), and the larger the surface area of the electrodes, the higher the capacitance. Considering the above, many efforts are made to increase the capacitance of the shrinking capacitors by reducing the thickness of the dielectric layers, using a high-k dielectric layer, and/or increasing the surface area of the electrodes. For example, cylindrical metal electrodes (specifically, capacitor-over-bit line (COB)-type cylindrical lower electrodes and shallow trench isolation) having a three-dimensional shape and an increased height to width aspect ratio are being manufactured because they can provide sufficient capacitance in a relatively small memory cell area.

According to a known method of forming a cylindrical lower electrode, as shown schematically in FIG. 1, photolithography may be used to form cylindrical holes that define a lower electrode in a sacrificial insulating layer 14 (FIG. 1B), followed by the anisotropic deposition of a layer of the lower electrode 16 and the deposition of a capping insulating layer 18 such that the lower electrode hole is completely filled with the capping insulating layer 18 (FIG. 1C). Thereafter, the capping insulating layer 18 and the lower electrode 16 are planarized until the sacrificial insulating layer 14 is exposed (FIG. 1D), followed by the selective removal of the capping insulating layer 18 and the sacrificial insulating layer 14, e.g., using a wet clean, to expose the outer walls and the inner walls of the cylindrical lower electrode 16 (FIG. 1E). Thereafter, a capacitor dielectric layer and a top electrode layer may be sequentially formed over the cylindrical lower electrode thereby forming the capacitor.

Typically, the capping insulating layer 18 and the sacrificial insulating layer 14 are comprised of silicon oxide materials including, but not limited to, silicon oxide, plasma enhanced tetraethyl orthosilicate (P-TEOS), borophosphosilicate glass (BPSG), plasma enhanced oxide (PEOX), high density plasma oxide (HDP), phosphosilicate glass (PSG), spin-on-dielectrics (SOD), thermal oxide, updoped silicate glass, sacrificial oxides, silicon-containing organic polymers, silicon-containing hybrid organic/inorganic materials, organosilicate glass (OSG), TEOS, fluorinated silicate glass (FSG), hemispherical grain (HSQ), carbon-doped oxide (CDO) glass (i.e., AURORA™, CORAL™, BLACK DIAMOND™, OSG, FSG, ultra low-k dielectric), and combinations thereof, and the lower electrode is comprised of silicon, ruthenium, titanium, titanium nitride, tantalum, tantalum nitride, Ta₂O₅/TiO₂, copper, tungsten, W/WN, aluminum, nickel, cobalt, and silicides thereof; Hemispherical Grain (HSG)-merged Al₂O₃/HfO₂, HSG-merged Al₂O₃, HSG-merged HfO₂, HSG-merged high-k material(s), Al/Cu, alloys of Al, alloys of Cu, hafnium oxides, hafnium oxysilicates, AlO/HfO, zirconium oxides, lanthanide oxides, titanates, strontium-based materials, high-k materials, and combinations thereof. Further, the device substrate 12, may includes an etch stop layer including SiN, SiBN, BN, and other nitrogen-containing species. Depending on the desired results, adjacent materials may also include etch stop layers such as silicon carbide (SiC), silicon carbon nitride (SiCN), silicon carbon oxide (SiCO), silicon oxynitride (SiON), copper, silicon germanium (SiGe), SiGeB, SiGeC, AlAs, InGaP, InP, InGaAs, and combinations thereof. Removing the capping and the insulating layers using a wet clean has been challenging because the aspect ratio of the cylindrical features (i.e., the ratio between the height of the cylinder and the width of the cylinder) is very high, typically greater than 5:1. In addition, the wet clean must selectively remove the capping and the insulating layers without substantially damaging the lower electrode, the device substrate, and/or the etch stop layer materials. Importantly, the complete and effective cleaning is essential to the performance of the memory device and thus, reliable cleaning methods are critical towards device fabrication.

There are several technological disadvantages to using aqueous-based wet cleaning solutions. Water has a high surface tension which limits or prevents access to the smaller image nodes with high aspect ratios, and therefore, removing the residues from the crevices or grooves becomes very difficult. In addition, aqueous-based etchant formulations often leave once dissolved solutes behind in the trenches and/or vias upon evaporative drying, which inhibit conduction and reduce device yield. Furthermore, porous low-k dielectric materials do not have sufficient mechanical strength to withstand the destructive forces (capillary stress) of high surface tension liquids, resulting in pattern collapse of the structures. Moreover, aqueous cleans can strongly alter important material properties of the low-k materials such as the dielectric constant, mechanical strength, moisture uptake, coefficient of thermal expansion, and adhesion to different substrates. Thus, a new generation of cleaning chemistries compatible with these new advanced devices is being developed. Dense fluids, including supercritical fluids (SCF), provide an alternative method for removing bulk and ion-implanted photoresist and/or post-etch residue from the microelectronic device. SCFs diffuse rapidly, have low viscosity, near zero surface tension, and can penetrate easily into deep trenches and vias. Further, because of their low viscosity, SCFs can rapidly transport dissolved species. SCFs are highly non-polar and as such, many species, including polar and non-polar species, are not adequately solubilized therein. Towards that end, additional components must be added to the SCCO₂ composition to enhance the removal capacity of said composition for the material to be removed.

It would therefore be a significant advance in the art to provide an improved composition that overcomes the deficiencies of the prior art relating to the removal of capping and insulating layers, e.g., silicon oxide-containing materials and silicon-containing organic polymers, silicon-containing hybrid organic/inorganic materials, organosilicate glass (OSG), TEOS, fluorinated silicate glass (FSG), hemispherical grain (HSQ), and carbon-doped oxide (CDO) glass, from microelectronic devices. The improved composition is useful as a liquid or in a dense fluid phase. The improved composition shall effectively remove capping and the insulating layers without substantially over-etching the lower electrode, the device substrate, and/or the etch stop layer materials.

### SUMMARY OF THE INVENTION

The present invention generally relates to removal compositions that selectively remove silicon-containing layers, e.g., capping and insulating layers and silicon-containing organic polymers, silicon-containing hybrid organic/inorganic materials, organosilicate glass (OSG), TEOS, fluorinated silicate glass (FSG), and/or carbon-doped oxide (CDO) glass, relative to lower electrodes of a memory device, e.g., TiN, and etch stop materials, e.g., SiN, from a microelectronic device having such material(s) thereon.

One aspect of the invention relates to a removal composition comprising at least one organic solvent, at least one etchant, optionally at least one surfactant, optionally at least one amine, optionally water, and optionally at least one corrosion inhibitor, wherein said removal composition is suitable for removing silicon-containing materials selected from the group consisting of capping and insulating layers, silicon oxide, plasma enhanced tetraethyl orthosilicate (P-TEOS), borophosphosilicate glass (BPSG), plasma enhanced oxide (PEOX), high density plasma oxide (HDP), phosphosilicate glass (PSG), spin-on-dielectrics (SOD), thermal oxide, updoped silicate glass, sacrificial oxides, silicon-containing organic polymers, silicon-containing hybrid organic/inorganic materials, organosilicate glass (OSG), TEOS, fluorinated silicate glass (FSG), hemispherical grain (HSQ), carbon-doped oxide (CDO) glass, and combinations thereof, from a microelectronic device having said material thereon. The removal composition may further comprise at least one corrosion inhibitor and/or at least one dense fluid.

Another aspect of the invention relates to a removal composition comprising at least one organic solvent, at least one etchant, wherein said composition is further characterized by comprising at least one of the following components (I)-(VIII):

(I) water;

(II) at least one surfactant;

(III) at least one amine;

(IV) water and at least one amine;

(V) at least one amine and at least one surfactant;

(VI) water and at least one surfactant;

(VII) water, at least one amine, and at one least surfactant; or

(VIII) at least one corrosion inhibitor,

wherein said removal composition is suitable for removing silicon-containing material from a microelectronic device having said material thereon.

In another aspect, the invention relates to a removal composition comprising, consisting of, or consisting essentially of at least one organic solvent, at least one etchant, water, and at least one amine, wherein said removal composition is suitable for removing silicon-containing material from a microelectronic device having said material thereon. The removal composition may further comprise, consist of, or consist essentially of at least one corrosion inhibitor and/or at least one dense fluid.

Another aspect of the invention relates to a removal composition comprising, consist of, or consist essentially of at least one organic solvent, at least one etchant, and at least one amine, wherein said removal composition is suitable for removing silicon-containing material from a microelectronic device having said material thereon. The removal composition may further comprise, consist of, or consist essentially of at least one corrosion inhibitor and/or at least one dense fluid.

Still another aspect of the invention relates to a removal composition comprising, consist of, or consist essentially of at least two organic solvents and at least one etchant, wherein at least one of the organic solvents is a fluorinated solvent present in an amount less than about 85 wt. %, based on the total weight of the composition, and wherein said removal composition is suitable for removing silicon-containing material from a microelectronic device having said material thereon. The removal composition may further comprise, consist of, or consist essentially of at least one corrosion inhibitor and/or at least one dense fluid.

In still another embodiment, the invention relates to a removal composition comprising, consist of, or consist essentially of at least one organic solvent, at least one etchant, and at least one surfactant, wherein said removal composition is suitable for removing silicon-containing material from a microelectronic device having said material thereon. The removal composition may further comprise, consist of, or consist essentially of at least one corrosion inhibitor and/or at least one dense fluid.

Another embodiment of the invention relates to a kit comprising, in one or more containers, one or more of the following reagents for forming a removal composition, said one or more reagents selected from the group consisting of at least one organic solvent, at least one etchant, optionally at least one surfactant, optionally at least one amine, and optionally water, and wherein the kit is adapted to form a removal composition suitable for removing silicon-containing material from a microelectronic device having said material thereon.

In yet another embodiment, the invention relates to a method of removing silicon-containing material from a microelectronic device having said material thereon, said method comprising contacting the microelectronic device with a removal composition for sufficient time to at least partially remove said material from the microelectronic device, wherein the removal composition includes at least one organic solvent, at least one etchant, optionally at least one surfactant, optionally at least one amine, and optionally water.

In yet another embodiment, the invention relates to a method of removing silicon-containing material from a microelectronic device having said material thereon, said method comprising contacting the microelectronic device with a removal composition for sufficient time to at least partially remove said material from the microelectronic device, wherein the removal composition includes at least one dense fluid, at least one organic solvent, at least one etchant, optionally at least one surfactant, optionally at least one amine, and optionally water.

Another embodiment of the invention relates to a method of removing silicon-containing material from a microelectronic device having said material thereon, said method comprising contacting the microelectronic device with a removal composition for sufficient time to at least partially remove said material from the microelectronic device, wherein the removal composition includes at least one organic solvent, at least one etchant, wherein said composition is further characterized by comprising at least one of the following components (I)-(VII):

(I) water;

(II) at least one surfactant;

(III) at least one amine;

(IV) water and at least one amine;

(V) at least one amine and at least one surfactant;

(VI) water and at least one surfactant;

(VII) water, at least one amine, and at least one surfactant; or

(VIII) at least one corrosion inhibitor.

In another aspect, the present invention relates to a method of rinsing a microelectronic device having a memory device structure thereon following removal of silicon-containing material, wherein the method comprises:
(a) rinsing the microelectronic device with a first rinsing composition at first rinsing conditions following contact with a removal composition formulated to remove silicon-containing material;
(b) rinsing the microelectronic device with a second rinsing composition at second rinsing conditions following contact with the first rinsing composition; and
(c) drying the microelectronic device following contact with the second rinsing composition.

In a further aspect, the present invention relates to a method of manufacturing a microelectronic device, said method comprising contacting the microelectronic device with a removal composition described herein for sufficient time to selectively remove silicon-containing material from the microelectronic device relative to lower electrodes of a memory device and etch stop layer material(s). This aspect of the invention may further comprise the deposition of a capacitor dielectric layer onto the exposed lower electrode. The method may further comprise the deposition of a top electrode layer onto the capacitor dielectric layer.

Yet another aspect of the invention relates to improved microelectronic devices, and products incorporating same, made using the methods of the invention comprising removing silicon-containing material from the microelectronic device having said materials thereon, using the methods and/or compositions described herein, and optionally, incorporating the microelectronic device into a product.

Another aspect of the invention relates to an article of manufacture comprising a removal composition, silicon-containing material, a lower electrode of a memory device, and an etch stop layer, wherein the removal composition comprises at least one organic solvent, at least one etchant, optionally at least one surfactant, optionally at least one amine, and optionally water.

Other aspects, features and advantages of the invention will be more fully apparent from the ensuing disclosure and appended claims.

### BRIEF DESCRIPTION OF THE DRAWINGS

FIG. 1 represents sectional views illustrating a conventional method of forming a cylindrical lower electrode on a microelectronic device substrate.

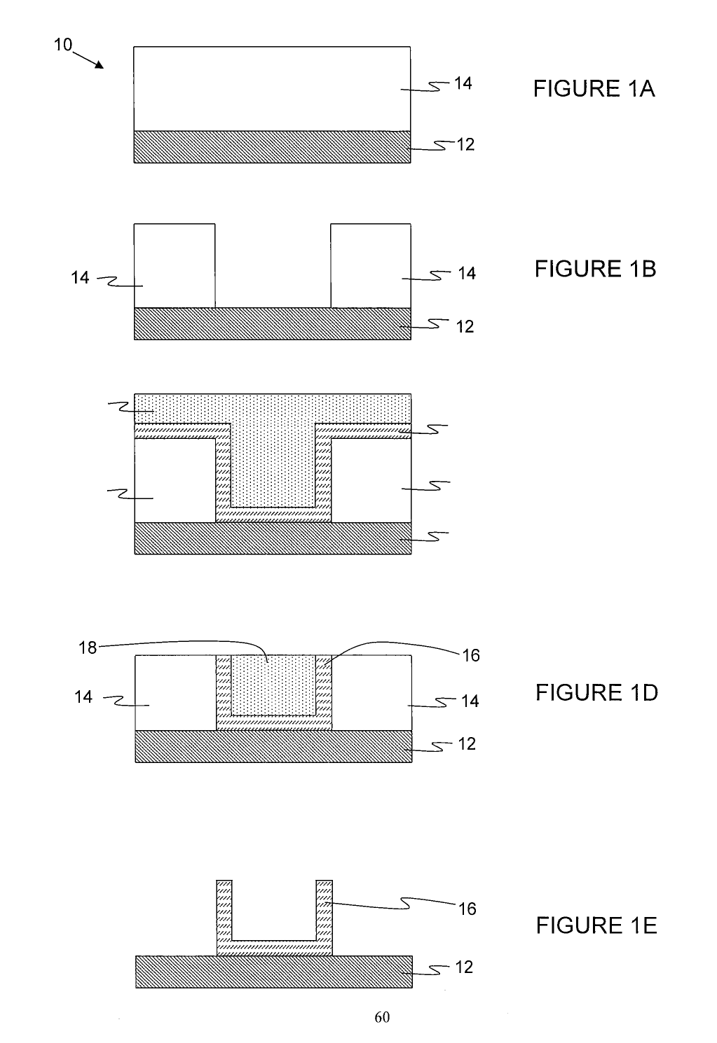

### DETAILED DESCRIPTION OF THE INVENTION, AND PREFERRED EMBODIMENTS THEREOF

The present invention relates generally to removal compositions that remove silicon-containing insulating layers, e.g., capping and insulating layers, from a microelectronic device having such layer(s) thereon.

For ease of reference, “microelectronic device” corresponds to semiconductor substrates, memory devices, flat panel displays, solar cells and photovoltaics, and microelectromechanical systems (MEMS), manufactured for use in microelectronic, integrated circuit, or computer chip applications. It is to be understood that the term “microelectronic device” is not meant to be limiting in any way and includes any substrate that will eventually become a microelectronic device or microelectronic assembly. As defined herein, “memory device” corresponds to volatile memory (e.g., DRAM and SRAM), non-volatile memory (e.g., EEPROM, flash EEPROM, shallow trench isolation (STI), ferroelectric RAM and phase-change RAM), and combinations thereof.

“Dense fluid,” as used herein, corresponds to a supercritical fluid or a subcritical fluid. The term “supercritical fluid” is used herein to denote a material which is under conditions of not lower than a critical temperature, T_{c}, and not less than a critical pressure, Pc, in a pressure-temperature diagram of an intended compound. Supercritical fluids useful in the present invention include CO₂, which may be used alone or in an admixture with another additive such as Ar, NH₃, N₂, CH₄, C₂H₄, CHF₃, C₂H₆, n-C₃H₈, H₂O, N₂O and the like. The term “subcritical fluid” describes a solvent in the subcritical state, i.e., below the critical temperature and/or below the critical pressure associated with that particular solvent. Preferably, the subcritical fluid is a high pressure liquid of varying density.

As defined herein, “substantially over-etching” corresponds to greater than about 10% removal, more preferably greater than about 5% removal, even more preferably greater than about 2% removal, and most preferably greater than about 1% removal, of the lower electrode, the device substrate, and/or the etch stop layer material(s) following contact, according to the process of the invention, of the removal composition with the microelectronic device having said material(s) thereon.

As used herein, “silicon-containing material” corresponds to capping and insulating layers and silicon-containing organic polymers, silicon-containing hybrid organic/inorganic materials, organosilicate glass (OSG), TEOS, plasma enhanced tetraethyl orthosilicate (P-TEOS), silicon oxide, fluorinated silicate glass (FSG), hemispherical grain (HSQ), carbon-doped oxide (CDO) glass (i.e., AURORA™, CORAL™, BLACK DIAMOND™, OSG, FSG, ultra low-k dielectric), borophosphosilicate glass (BPSG), plasma enhanced oxide (PEOX), high density plasma oxide (HDP), phosphosilicate glass (PSG), spin-on-dielectrics (SOD), thermal oxide, updoped silicate glass, sacrificial oxides, silicon-containing organic polymers, and combinations thereof. The silicon-containing material does not include a silicon-containing device substrate such as, but not limited to, bare silicon; polysilicon; silicon carbide; silicon on sapphire; doped glass; undoped glass; epitaxial silicon; and combinations thereof.

As defined herein, “etch stop layers” include silicon carbide (SiC), silicon nitride, silicon carbon nitride (SiCN), silicon carbon oxide (SiCO), silicon oxynitride (SiON), copper, silicon germanium (SiGe), SiGeB, SiGeC, AlAs, InGaP, InP, InGaAs, and combinations and salts thereof.

As used herein, “about” is intended to correspond to +5% of the stated value.

As used herein, “suitability” for removing silicon-containing layers, e.g., capping and insulating material, from a microelectronic device having said layers thereon corresponds to at least partial removal of said layers from the microelectronic device. Preferably, at least 85% of the layers to be removed are removed from the microelectronic device using the compositions of the invention, more preferably at least 90%, even more preferably at least 95%, and most preferably at least 99% of the layers to be removed are removed.

All reference to “cylindrical lower electrodes” herein is not intended to be limiting. It is contemplated that the lower electrodes may be fabricated to have other cross-sectional two-dimensional shapes including, but not limited to, triangular, square, rectangular, polygonal (wherein the lengths of the segments may be the same or different from one another), circular, elliptical, and irregular.

As defined herein, “substantially devoid” corresponds to less than about 0.5 wt. %, more preferably less than 0.05 wt. %, and most preferably less than 0.005 wt. % of the composition, based on the total weight of said composition.

Compositions of the invention may be embodied in a wide variety of specific formulations, as hereinafter more fully described.

In all such compositions, wherein specific components of the composition are discussed in reference to weight percentage ranges including a zero lower limit, it will be understood that such components may be present or absent in various specific embodiments of the composition, and that in instances where such components are present, they may be present at concentrations as low as 0.001 weight percent, based on the total weight of the composition in which such components are employed.

The present invention relates to cleaning a microelectronic device in which vertically oriented memory elements (e.g., electrodes of a capacitor) are present. Specifically, this invention is based on the discovery of compositions that are highly efficacious for the removal of silicon-containing material, including silicon oxide, P-TEOS and BPSG, from a memory device, while maintaining the integrity of the lower electrode, e.g., titanium nitride (TiN), and etch stop layer, e.g., silicon nitride (SiN). Even more specifically, the present invention relates to liquid and dense fluid compositions that selectively remove SiO₂, P-TEOS and BPSG relative to the TiN and SiN layers, wherein the aspect ratio of the features may be in a range from about 5:1 to about 20:1, e.g., about 13:1 to about 16:1.

In one aspect, the invention relates to a liquid removal composition useful in selectively removing silicon-containing material from a semiconductor device. In one embodiment, the composition of the present invention includes at least one etchant and at least one organic solvent. Yet another embodiment of the present invention includes at least one etchant, at least one organic solvent, and water. In another embodiment, the composition of the present invention includes at least one etchant, at least one organic solvent, and at least one surfactant. In yet another embodiment, the composition of the invention includes at least one etchant, at least one organic solvent, and at least one amine. In yet another embodiment, the composition of the invention includes at least one etchant, at least one organic solvent, at least one amine, and at least one surfactant. In another embodiment, the composition of the invention includes at least one etchant, at least one organic solvent, water, and at least one amine. In still another embodiment, the composition of the invention includes at least one etchant, at least one organic solvent, water, and at least one surfactant. Another embodiment of the invention includes at least one etchant, at least one organic solvent, water, at least one amine, and at least one surfactant. In each of the embodiments, the composition of the invention may further comprise, consist of or consist essentially of at least one corrosion inhibitor, e.g., a TiN corrosion inhibitor.

In the broad practice of the invention, the removal compositions of the invention may comprise, consist of, or consist essentially of: (i) at least one etchant and at least one organic solvent; (ii) at least one etchant, at least one organic solvent, and water; (iii) at least one etchant, at least one organic solvent, and at least one surfactant; (iv) at least one etchant, at least one organic solvent, and at least one amine; (v) at least one etchant, at least one organic solvent, at least one amine, and at least one surfactant; (vi) at least one etchant, at least one organic solvent, water, and at least one amine; (vii) at least one etchant, at least one organic solvent, water, and at least one surfactant; and (viii) at least one etchant, at least one organic solvent, water, at least one amine, and at least one surfactant. In each of the embodiments, the composition of the invention may further comprise, consist of, or consist essentially of at least one corrosion inhibitor, e.g., a TiN corrosion inhibitor.

In one embodiment, the present invention relates to a liquid removal composition for removing silicon-containing material. The liquid removal composition according to one embodiment comprises at least one organic solvent, at least one etchant, optionally at least one surfactant, optionally at least one amine, optionally water, and optionally at least one corrosion inhibitor, present in the following ranges, based on the total weight of the composition:

| component | | more preferably | most preferably |
|---|---|---|---|
| of | preferably (wt. %) | (wt. %) | (wt. %) |
| organic | about 0.1% to about | about 50% to | about 90% to |
| solvent(s) | 99% | about 99% | about 99% |
| etchant(s) | about 0.1% to about | about 0.1% to | about 0.1% to |
| | 20% | about 10% | about 3% |
| surfactant(s) | 0% to about 10% | 0% to about 8% | 0% to about 5% |
| amine(s) | 0% to about 10% | 0% to about 8% | 0% to about 5% |
| water | 0% to about 10% | 0% to about 8% | 0% to about 5% |
| corrosion | 0% to about 10.0% | 0% to about | 0% to about |
| inhibitor(s) | | 10.0% | 10.0% |

When present, the lower limit for surfactant(s), amine(s), corrosion inhibitor(s) and/or water is 0.001 wt. %. The range of weight percent ratios of the components of this embodiment of the removal composition is about 1 to about 100 solvent(s) relative to etchant (s), preferably about 10 to about 60, and most preferably about 30 to about 50.

In another preferred embodiment, the invention relates to a liquid removal composition comprising at least one organic solvent, at least one etchant, water, optionally at least one amine, and optionally at least one surfactant. In a particularly preferred embodiment, the invention relates to a liquid removal composition comprising at least one organic solvent, at least one etchant, water, at least one amine, optionally at least one surfactant, and optionally at least one corrosion inhibitor, present in the following ranges, based on the total weight of the composition:

| component | | more preferably | most preferably |
|---|---|---|---|
| of | preferably (wt. %) | (wt. %) | (wt. %) |
| organic | about 0.1% to about | about 50% to | about 85% to |
| solvent(s) | 99% | about 99% | about 99% |
| etchant(s) | about 0.1% to about | about 0.1% to | about 0.1% to |
| | 20% | about 10% | about 5% |
| surfactant(s) | 0% to about 10% | 0% to about 8% | 0% to about 5% |
| amine(s) | 0% to about 10% | 0% to about 8% | 0% to about 5% |
| water | about 0.01% to | about 0.1% to | about 0.01% to |
| | about 10% | about 8% | about 5% |
| corrosion | 0% to about 10.0% | 0% to about | 0% to about |
| inhibitor(s) | | 10.0% | 10.0% |

The range of weight percent ratios of the components of this embodiment of the removal composition is: about 0.01 to about 5 etchant(s) relative to water, preferably about 0.1 to about 3, and most preferably about 0.5 to about 1.5; about 1 to about 100 organic solvent(s) relative to water, preferably about 10 to about 80, and most preferably about 20 to about 55.

In another preferred embodiment, the invention relates to a liquid removal composition comprising at least one organic solvent, at least one etchant, water, at least one amine, and optionally at least one surfactant. In a particularly preferred embodiment, the invention relates to a liquid removal composition comprising at least one organic solvent, at least one etchant, water, at least one amine, optionally at least one surfactant, and optionally at least one corrosion inhibitor, present in the following ranges, based on the total weight of the composition:

| component | | more preferably | most preferably |
|---|---|---|---|
| of | preferably (wt. %) | (wt. %) | (wt. %) |
| organic | about 0.1% to about | about 50% to | about 85% to |
| solvent(s) | 99% | about 99% | about 99% |
| etchant(s) | about 0.1% to about | about 0.1% to | about 0.1% to |
| | 20% | about 10% | about 5% |
| surfactant(s) | 0% to about 10% | 0% to about 8% | 0% to about 5% |
| amine(s) | about 0.01% to | about 0.1% to | about 0.01% to |
| | about 10% | about 8% | about 5% |
| water | about 0.01% to | about 0.1% to | about 0.01% to |
| | about 10% | about 8% | about 5% |
| corrosion | 0% to about 10.0% | 0% to about | 0% to about |
| inhibitor(s) | | 10.0% | 10.0% |

The range of weight percent ratios of the components of this embodiment of the removal composition is: about 0.1 to about 5 etchant(s) relative to amine(s), preferably about 0.5 to about 4, and most preferably about 1 to about 3; about 1 to about 100 solvent(s) relative to amine(s), preferably about 20 to about 80, and most preferably about 40 to about 55; and about 0.1 to about 5 water relative to amine(s), preferably about 0.5 to about 4, and most preferably about 1 to about 3.

In another preferred embodiment, the invention relates to a liquid removal composition comprising at least one organic solvent, at least one etchant, and one additional component selected from the group consisting of an amine, a surfactant, water, corrosion inhibitor, and combinations thereof, present in the following ranges, based on the total weight of the composition:

| | | more | most |
|---|---|---|---|
| | preferably | preferably | preferably |
| component of | (wt. %) | (wt. %) | (wt. %) |
| organic solvent(s) | about 0.1% to | about 50% to | about 90% to |
| | about 99% | about 99% | about 99% |
| etchant(s) | about 0.1% to | about 0.1% to | about 0.1% to |
| | about 20% | about 10% | about 5% |
| one additional | about 0.01% to | about 0.1% to | about 0.1% to |
| component (surfactant, | about 10% | about 8% | about 3% |
| amine, water and/or | | | |
| corrosion inhibitor) | | | |

When the additional component is water, the range of weight percent ratios of the components is: about 0.05 to about 5 etchant(s) relative to water, preferably about 0.1 to about 3, and most preferably about 0.5 to about 2; and about 1 to about 70 solvent(s) relative to water, preferably about 10 to about 60, and most preferably about 25 to about 50. When the additional component is surfactant, the range of weight percent ratios of the components is: about 1 to about 100 etchant(s) relative to surfactant(s), preferably about 5 to about 50; and about 10 to about 1000 solvent(s) relative to surfactant(s), preferably about 90 to about 950. When the additional component is amine, the range of weight percent ratios of the components is: about 0.1 to about 5 etchant(s) relative to amine(s), preferably about 0.5 to about 43, and most preferably about 1 to about 2.5; and about 100 to about 300 solvent(s) relative to amine(s), preferably about 150 to about 200.

Importantly, the overall composition efficiently removes silicon-containing material from a microelectronic device while not substantially over-etching the lower electrode, the device substrate, and/or the etch stop layer materials.

When present, the water is preferably deionized.

The removal compositions are formulated to have surface tension in a range from about 12 dynes cm⁻¹ to about 30 dynes cm⁻¹, preferably about 16 dynes cm⁻¹ to about 25 dynes cm⁻¹.

Etchants are added to react with the silicon-containing material and assist in the removal of same from the microelectronic device. Etchants contemplated for use include fluorides, amines, and/or hydroxide salts including, but not limited to: hydrogen fluoride (HF); xenon difluoride (XeF₂); fluorosilicic acid (H₂SiF₆); fluoroboric acid; tetrabuylammonium tetrafluoroborate (TBA-BF₄); ammonium fluorosilicate ((NH₄)₂SiF₆); tetramethylammonium hexafluorophosphate; ammonium fluoride (NH₄F); tetraalkylammonium fluoride (NMF); alkyl hydrogen fluoride (NRH₃F); ammonium hydrogen bifluoride (NH₅F₂); dialkylammonium hydrogen fluoride (NR₂H₂F); trialkylammonium hydrogen fluoride (NR₃HF); trialkylammonium trihydrogen fluoride (NR₃:3HF); anhydrous hydrogen fluoride pyridine complex; anhydrous hydrogen fluoride triethylamine complex; and amine hydrogen fluoride complexes; where R may be the same as or different from one another and is selected from the group consisting of straight-chained or branched C₁-C₆ alkyl groups (e.g., methyl, ethyl, propyl, butyl, pentyl, hexyl) and where the amine (either as the amine hydrogen fluoride complex or the stand alone amine etchant) includes straight-chained or branched C₁-C₂₀ alkylamines, substituted or unsubstituted C₆-C₁₀ arylamines, glycolamines, alkanolamines, and amine-N-oxides including, but not limited to: pyridine; 2-ethylpyridine; 2-methoxypyridine and derivatives thereof such as 3-methoxypyridine; 2-picoline; pyridine derivatives; dimethylpyridine; piperidine; piperazine; triethylamine; triethanolamine; ethylamine, methylamine, isobutylamine, tert-butylamine, tributylamine, dipropylamine, dimethylamine, diglycol amine; monoethanolamine; pyrrole; isoxazole; 1,2,4-triazole; bipyridine; pyrimidine; pyrazine; pyridazine; quinoline; isoquinoline; indole; imidazole; N-methylmorpholine-N-oxide (NMMO); trimethylamine-N-oxide; triethylamine-N-oxide; pyridine-N-oxide; N-ethylmorpholine-N-oxide; N-methylpyrrolidine-N-oxide; N-ethylpyrrolidone-N-oxide; 1-methylimidazole; diisopropylamine; diisobutylamine; aniline; aniline derivatives; and combinations thereof. Alternatively, the etchant may comprise a hydroxide salt including, but not limited to, an alkali hydroxide, an alkaline earth metal hydroxide, a quaternary amine hydroxide, and combinations thereof. An anhydrous amine hydrogen fluoride complex is the preferred source due to its mild fluorination properties and better solubility in dense fluids, particularly dense CO₂.

Solvent species are added to serve as a solvent and assist in the penetration and dissolution of the oxide materials and inorganic residues. Solvents useful in the compositions of the invention may be non-polar or polar in nature. Illustrative non-polar species include, but are not limited to, toluene, decane, hexane, hexanes, octane, xylenes, odorless mineral spirits (petroleum naphtha), mineral spirits (hydrotreated heavy naphtha), phenoxy-2-propanol, propriophenone, cyclohexane, perfluoro-1,2-dimethylcyclobutane, perfluoro-1,2-dimethylcyclohexane, and perfluorohexane(s). Illustrative polar species include, but are not limited to, methanol, ethanol, 1-propanol, isopropanol, 1-butanol, 2-butanol, 3-methyl-1-butanol, allyl alcohol, and higher alcohols (including diols, triols, etc.), 2,2,3,3,4,4,5,5-octafluoro-1-pentanol, 1H,1H,9H-perfluoro-1-nonanol, perfluoroheptanoic acid, 1H,1H,7H-dodecafluoro-1-heptanol, perfluoropentanoic acid, 1H,1H,8H,8H-dodecafluoro-1,8-octanediol, 2,2,3,3,4,4,5,5-octafluoro-1,6-hexanediol, 5H-perfluoropentanoic acid, n-butyl heptafluorobutyrate, halogenated alcohols (such as 3-chloro-1,2-propanediol, 3-chloro-1-propanethiol, 1-chloro-2-propanol, 2-chloro-1-propanol, 3-chloro-1-propanol, 3-bromo-1,2-propanediol, 1-bromo-2-propanol, 3-bromo-1-propanol, 3-iodo-1-propanol, 4-chloro-1-butanol, 2-chloroethanol), tetrahydrofuran (THF), N-methylpyrrolidinone (NMP), N-octylpyrrolidinone, N-phenylpyrrolidinone, methyl formate, ethyl formate, propyl formate, butyl formate, 2-butanone, 3-pentanone, dimethyl formamide (DMF), dimethylsulfoxide (DMSO), dimethyl sulfide, ethanethiol, tetramethylene sulfone (sulfolane), diethyl ether, ethyl lactate, ethyl acetate, propyl acetate, isobutyl acetate, methyl butanoate, ethyl butanoate, ethyl benzoate, acetonitrile, methyl isobutyl ketone, methyl ethyl ketone, methyl propyl ketone, acetone, ethylene glycol, propylene glycol, amphiphilic species (e.g., diethylene glycol monomethyl ether, triethylene glycol monomethyl ether, diethylene glycol monoethyl ether, triethylene glycol monoethyl ether, ethylene glycol monopropyl ether, ethylene glycol monobutyl ether, diethylene glycol monobutyl ether (i.e., butyl carbitol), triethylene glycol monobutyl ether, ethylene glycol monohexyl ether, diethylene glycol monohexyl ether, ethylene glycol phenyl ether, propylene glycol methyl ether, dipropylene glycol methyl ether, tripropylene glycol methyl ether, dipropylene glycol dimethyl ether, dipropylene glycol ethyl ether, propylene glycol n-propyl ether, dipropylene glycol n-propyl ether (DPGPE), tripropylene glycol n-propyl ether, propylene glycol n-butyl ether, dipropylene glycol n-butyl ether, tripropylene glycol n-butyl ether, propylene glycol phenyl ether), dioxane, methyl carbitol, butyl carbitol, butyrolactone, butylene carbonate, ethylene carbonate, propylene carbonate, acetic acid, trifluoroacetic acid, or combinations thereof. Preferably, the solvent includes a fluorinated solvent such as 2,2,3,3,4,4,5,5-octafluoro-1-pentanol, methanol, propylene carbonate, ethylene glycol, and combinations thereof. In one embodiment, when the composition includes only organic solvent(s) and etchant(s), and at least one of the organic solvents includes fluorinated solvents, the composition cannot include more than 87 wt. % fluorinated solvent, more preferably no more than about 85 wt. % fluorinated solvent, and most preferably no more than about 83 wt. % fluorinated solvent, based on the total weight of the composition.

Surfactants may be added to lower the surface tension of the formulation and to eliminate leaning or collapse of the features. Surfactants contemplated include nonionic, anionic, cationic (based on quaternary ammonium cations) and/or zwitterionic surfactants including, but not limited to, fluoroalkyl surfactants, SURFONYL® 104, TRITON™ CF-21, ZONYL® UR, ZONYL® FSO-100, ZONYL® FSN-100, 3M™ Fluorad™ fluorosurfactants (e.g., FC-4430 and FC-4432), MASURF® P FS-710, MASURF® FS-780, dioctylsulfosuccinate salt, 2,3-dimercapto-1-propanesulfonic acid salt, dodecylbenzenesulfonic acid, polyethylene glycols, polypropylene glycols, polyethylene or polypropylene glycol ethers, carboxylic acid salts, R₁ benzene sulfonic acids or salts thereof (where the R₁ is a straight-chained or branched C₈ to C₁₈ alkyl group), polyacrylate polymers, dinonylphenyl polyoxyethylene, silicone or modified silicone polymers, acetylenic diols or modified acetylenic diols, amphiphilic fluoropolymers, alkylammonium or modified alkylammonium salts, sodium dodecyl sulfate, aerosol-OT (AOT) and fluorinated analogues thereof, alkyl ammonium, perfluoropolyether surfactants, 2-sulfosuccinate salts, phosphate-based surfactants, sulfur-based surfactants, and acetoacetate based polymers, as well as combinations comprising at least one of the foregoing surfactants. Alternatively, the surfactants may include water soluble polymers including, but not limited to, polyethylene glycol (PEG), polyethylene oxide (PEO), polyvinyl pyrrolidone (PVP), cationic polymers, nonionic polymers, anionic polymers, hydroxyethylcellulose (HEC), acrylamide polymers, poly(acrylic acid), carboxymethylcellulose (CMC), sodium carboxymethylcellulose (Na CMC), hydroxypropylmethylcellulose, polyvinylpyrrolidone K30, BIOCARE™ polymers, DOW™ latex powders (DLP), ETHOCEL™ ethylcellulose polymers, KYTAMER™ PC polymers, METHOCEL™ cellulose ethers, POLYOX™ water soluble resins, SoftCAT™ polymers, UCARE™ polymers, UCON™ fluids, and combinations thereof. The water soluble polymers may be short-chained or long-chained polymers and may be combined with the nonionic, anionic, cationic, and/or zwitterionic surfactants of the invention. When surfactants are included in the compositions of the invention, preferably defoaming agents are added in a range from 0 to 5 wt. %, based on the total weight of the composition. Defoaming agents contemplated include, but are not limited to, fatty acids, alcohols (simple or polyol) and amines such as caprylic acid diglyceride, lecithin, magnesium carbonate, polyethylene homopolymers and oxidised homopolymer M3400, dimethopolysiloxane-based, silicone-based, AGITAN™, and fatty acid polyether types such as LUMITEN™, oils, and combinations thereof.

Amines may be added to increase the oxide etch rates in the presence of the fluoride etchant source. The speciation between the acid (A-H) and base (B) changes, depending on the amine basic strength. The intermediate complex A-H—B strongly influences the rate of various oxide materials. As such, we can selectively etch one oxide material over the other or adjust the amine concentration so that both or all of the oxide materials have similar etch rates. Amines contemplated herein include, but are not limited to, alkylamines, arylamines, glycolamines, alkanolamines, triazoles, thiazoles, tetrazoles, imidazoles, and amine-N-oxides including, but not limited to, pyridine, 2-ethylpyridine, 2-methoxypyridine and derivatives thereof such as 3-methoxypyridine, 2-picoline, pyridine derivatives, dimethylpyridine, piperidine, piperazine, triethylamine, triethanolamine, ethylamine, methylamine, isobutylamine, tert-butylamine, tributylamine, dipropylamine, dimethylamine, diglycol amine, monoethanolamine, pyrrole, isoxazole, 1,2,4-triazole, bipyridine, pyrimidine, pyrazine, pyridazine, quinoline, isoquinoline, indole, imidazole, N-methylmorpholine-N-oxide (NMMO), trimethylamine-N-oxide, triethylamine-N-oxide, pyridine-N-oxide, N-ethylmorpholine-N-oxide, N-methylpyrrolidine-N-oxide, N-ethylpyrrolidine-N-oxide, 1-methylimidazole, diisopropylamine, diisobutylamine, pentamethyldiethylenetriamine (PMDETA), aniline, aniline derivatives, and combinations thereof. Preferably, the amine component comprises 1-methylimidazole. It should be appreciated that additional amine may be added even when the etchant component comprises amine.

When present, the corrosion inhibitors preferably passivate the TiN surface. Preferred TiN corrosion inhibitors include, but are not limited to, ascorbic acid, DL-methionine, Korantin® PP (BASF, Mount Olive, N.J.), dimethylglyoxime, phosphonic acids such as nitrilotris(methylene)triphosphonic acid (e.g., Dequest 2000EG, Solutia, Inc., St. Louis, Mo.) 1-hydroxyethylidene-1,1-diphosphonic acid (HEDP), ethylenedinitrilotetra(methylene-phosphonic) acid (EDTMP); phosphoric acids such as pyrophosphoric acid; their salts; L-cysteine, and combinations thereof.

The liquid removal composition is preferably substantially devoid of any combination of peroxides and oxidizing agents in general, polymeric species such as polymeric alcohols and polymeric amines and any other resinous compounds, abrasive materials, quaternary ammonium salts, metal halide corrosion inhibitors having the formula W_{z}MX_{y}, and silylating agents. The liquid removal composition preferably includes less than about 10 wt. %, more preferably less than about 8 wt. % sulfoxide and/or sulfone species, and preferably less than 10 wt %, more preferably less than about 8 wt % inorganic acids.

The liquid removal composition may be formulated in the following formulations A-W, wherein the active ingredients in the formulations are at the following ratios to be used in an aqueous solution:

### Example A

Pyridine:HF (30%:70%): 7.5 wt %; Sulfolane: 10.3 wt %; Butyl carbitol: 82.2 wt %

### Example B

Pyridine:HF (30%:70%): 7.5 wt %; Sulfolane: 10.3 wt %; Butyl carbitol: 57.2 wt %; Propylene carbonate: 25.0 wt %

### Example C

Pyridine:HF (30%:70%): 7.5 wt %; Sulfolane: 10.3 wt %; Propylene carbonate: 82.2 wt %

### Example D

Pyridine:HF (30%:70%): 7.5 wt %; Sulfolane: 10.3 wt %; Butyl carbitol: 57.2 wt %; Methanol: 25.0 wt %

### Example E

Pyridine:HF (30%:70%): 7.5 wt %; Sulfolane: 10.0 wt %; Acetic acid: 82.5 wt %

### Example F

Pyridine:HF (30%:70%): 7.5 wt %; MeOH: 25.0 wt %; Acetic acid: 67.5 wt %

### Example G

Pyridine:HF (30%:70%): 7.5 wt %; MeOH: 92.5 wt %

### Example H

Pyridine:HF (30%:70%): 7.5 wt %; Methanol: 92.0 wt %; Water: 0.5 wt %

### Example I

Pyridine:HF (30%:70%): 7.5 wt %; Methanol: 89.5 wt %; Water: 3.0 wt %

### Example J

Pyridine:HF (30%:70%): 5.0 wt %; Methanol: 95.0 wt %

### Example K

HF: 3.05 wt %; Propylene carbonate: 79.90 wt %; Ethylene glycol: 14.40 wt %; Water: 2.55 wt %; 1,2,4-Triazole: 0.10 wt %

### Example L

HF: 3.16 wt %; Propylene carbonate: 82.35 wt %; Ethylene glycol: 6.78 wt %; Water: 3.00 wt %; 1-methylimidazole: 4.71 wt %

### Example M

HF: 2.88 wt %; Propylene carbonate: 82.35 wt %; Ethylene glycol: 7.06 wt %; Water: 3.00 wt %; 1-methylimidazole: 4.71 wt %

### Example N

HF: 2.88 wt %; Propylene carbonate: 85.11 wt %; Ethylene glycol: 7.06 wt %; Water: 3.00 wt %; 1-methylimidazole: 1.95 wt %

### Example O

HF: 2.88 wt %; Propylene carbonate: 85.01 wt %; Ethylene glycol: 7.06 wt %; Water: 3.00 wt %; 1-methylimidazole: 1.95 wt %; ZONYL FSO-100: 0.1 wt %

### Example P

HF: 2.88 wt %; Propylene carbonate: 85.01 wt %; Ethylene glycol: 7.06 wt %; Water: 3.00 wt %; 1-methylimidazole: 1.95 wt %; ZONYL FSN-100: 0.1 wt %

### Example Q

HF: 2.88 wt %; Propylene carbonate: 92.17 wt %; Water: 3.00 wt %; 1-methylimidazole: 1.95 wt %

### Example R

HF: 2.88 wt %; Propylene carbonate: 85.11 wt %; Propylene glycol: 7.06 wt %; Water: 3.00 wt %; 1-methylimidazole: 1.95 wt %

### Example S

HF: 2.88 wt %; Propylene carbonate: 87.06 wt %; Ethylene glycol: 7.06 wt %; Water: 3.00 wt %

### Example T

HF: 2.88 wt %; Propylene carbonate: 87.06 wt %; Propylene glycol: 7.06 wt %; Water: 3.00 wt %

### Example U

HF: 2.88 wt %; Propylene carbonate: 86.62 wt %; Water: 10.00 wt %; ZONYL FSO-100: 0.50 wt %

### Example V

HF: 4.90 wt %; Methanol: 44.50; Propylene carbonate: 45.00 wt %; Water: 5.10 wt %; ZONYL FSO-100: 0.50 wt %

### Example W

HF: 2.45 wt %; Propylene carbonate: 95.00 wt %; Water: 2.55 wt %.

In preferred embodiments of formulations A-W, the liquid removal composition comprises, consists of, or consists essentially of (i) a fluoride, a carbonate solvent and a glycol solvent, e.g., HF, propylene carbonate, and ethylene glycol; (ii) a fluoride, a carbonate solvent and water, e.g., HF, propylene carbonate and water; (iii) a fluoride, a carbonate solvent, a glycol solvent, and water, e.g., HF, propylene carbonate, ethylene glycol, and water; and (iv) a fluoride, a carbonate solvent, a glycol solvent, water, and an amine, e.g., HF, propylene carbonate, ethylene glycol, water, and an imidazole such as 1-methylimidazole. Preferably, the amount of propylene carbonate present in the liquid removal compositions is in a range from about 75 wt. % to about 95 wt. %. It was surprisingly discovered that water may be an important component of the liquid removal compositions of the invention because the water assists in the solubilization of fluorosilicate species that are the byproduct of the reaction of etchant, e.g., HF, with silicon-containing insulating layers, e.g., SiO₂. Towards that end, in another preferred embodiment, the liquid removal composition preferably includes less than about 5 wt. % water, more preferably less than about 4 wt. % water, based on the total weight of the liquid removal composition.

Alternatively, the liquid removal composition may be formulated in the following formulations AA-NN, wherein the active ingredients in the formulations are at the following ratios to be used in an aqueous solution:

### Example AA

Pyridine:HF (30%:70%): 5.00 wt %; Methanol: 94.90 wt %; ZONYL FSO-100: 0.10 wt %

### Example BB

Pyridine:HF (30%:70%): 5.00 wt %; Methanol: 94.50 wt %; ZONYL FSO-100: 0.50 wt %

### Example CC

Pyridine:HF (30%:70%): 5.00 wt %; Methanol: 94.00 wt %; ZONYL FSO-100: 1.00 wt %

### Example DD

Pyridine:HF (30%:70%): 5.00 wt %; Ethylene Glycol: 94.50 wt %; ZONYL FSO-100: 0.50 wt %

### Example EE

Pyridine:HF (30%:70%): 3.39 wt %; Ethylene Glycol:HF (96%:4%): 29.09 wt %; Propylene Carbonate: 65.91 wt %; ZONYL FSO-100: 1.61 wt %

### Example FF

Pyridine:HF (30%:70%): 2.50 wt %; 2,2,3,3,4,4,5,5-Octafluoro-1-pentanol: 96.50 wt %; 1-Methylimidazole: 1.01 wt %

### Example GG

Pyridine:HF (30%:70%): 5.00 wt %; 2,2,3,3,4,4,5,5-Octafluoro-1-pentanol: 47.00 wt %; Methanol: 48.00 wt %

### Example HH

Pyridine:HF (30%:70%): 2.50 wt %; 2,2,3,3,4,4,5,5-Octafluoro-1-pentanol: 95.75 wt %; 1-Methylimidazole: 1.25 wt %; ZONYL FSO-100: 0.50 wt %

### Example II

Pyridine:HF (30%:70%): 1.00 wt %; 2,2,3,3,4,4,5,5-Octafluoro-1-pentanol: 97.45 wt %; 1-Methylimidazole: 0.55 wt %; ZONYL FSO-100: 1.00 wt %

### Example JJ

Pyridine:HF (30%:70%): 0.85 wt %; 2,2,3,3,4,4,5,5-Octafluoro-1-pentanol: 98.60 wt %; 1-Methylimidazole: 0.55 wt %;

### Example KK

Pyridine:HF (30%:70%): 2.50 wt %; 2,3,3,4,4,5,5-Octafluoro-1-pentanol: 48.00 wt %; 1-Butanol: 49.50 wt %

### Example LL

Pyridine:HF (30%:70%): 2.50 wt %; 2,2,3,3,4,4,5,5-Octafluoro-1-pentanol: 48.00 wt %; 3-Methyl-1-Butanol: 49.50 wt %

### Example MM

Pyridine:HF (30%:70%): 0.70 wt %; 2,2,3,3,4,4,5,5-Octafluoro-1-pentanol: 98.75 wt %; 1-Methylimidazole: 0.55 wt %

### Example NN

Pyridine:HF (30%:70%): 0.70 wt %; 2,2,3,3,4,4,5,5-Octafluoro-1-pentanol: 98.85 wt %; 1-Methylimidazole: 0.45 wt %

In a preferred embodiment, e.g., formulations KK and LL, the composition comprises, consists of, or consists essentially of at least two organic solvents and at least one etchant, wherein at least one organic solvent is fluorinated. When one of the solvents is fluorinated, the range of weight percent ratios of is about 1 to about 40 solvent (for the cumulative fluorinated and non-fluorinated solvent component) relative to etchant (s), preferably about 10 to about 30, and most preferably about 20. For example, the composition may comprise, consist of, or consist essentially of: an amine:HF complex, e.g., pyridine:HF; 2,2,3,3,4,4,5,5-octafluoro-1-pentanol; and at least one substituted or unsubstituted, straight-chained or branched C₁-C₆ alcohol, e.g., 1-butanol and/or 3-methyl-1-butanol, wherein the composition is substantially devoid of added water. In another preferred embodiment, e.g., formulations JJ, MM and NN, the compositions comprise, consist of or consist essentially of about 98 wt. % to about 99 wt. % 2,2,3,3,4,4,5,5-octafluoro-1-pentanol, about 0.5 wt. % to about 0.90 wt. % amine:HF complex, e.g., pyridine:HF, and about 0.5 wt. % to about 1 wt. % amine, e.g., an imidazole such as 1-methylimidazole, wherein the composition is substantially devoid of added water. In still another preferred embodiment, the composition comprises, consists of, or consists essentially of amine:HF complex, e.g., pyridine:HF, at least one substituted or unsubstituted, straight-chained or branched C₁-C₆ alcohol, and an non-ionic surfactant, e.g., ZONYL FSO-100, where the removal composition is substantially devoid of added water. As defined herein, “added water” corresponds to water added by the user or the producer of the composition of the invention. Added water does not correspond to water often found in the commercial chemicals mixed together to form the composition of the invention.

In another embodiment of the invention, a concentrated liquid removal composition is provided that can be diluted for use as a removal solution. A concentrated composition, or “concentrate,” advantageously permits a user, e.g. a process engineer, to dilute the concentrate at the point of use. Dilution of the concentrated removal composition may be in a range from about 0.1:1 to about 1000:1, wherein the removal composition is diluted at or just before the tool with at least one solvent, e.g., liquid solvent or dense fluid. It is to be appreciated by one skilled in the art that following dilution, the range of ratios of the components disclosed herein should remain unchanged.

In yet another preferred embodiment, any of the liquid removal compositions described herein may further include insulating material, wherein the insulating material comprises a silicon-containing compound. Importantly, the insulating material may be dissolved and/or suspended in the removal composition of the invention.

The liquid removal compositions of the invention are easily formulated by simple addition of the respective ingredients and mixing to homogeneous condition. Furthermore, the liquid removal compositions may be readily formulated as single-package formulations or multi-part formulations that are mixed at or before the point of use, e.g., the individual parts of the multi-part formulation may be mixed at the tool or in a storage tank upstream of the tool. The concentrations of the respective ingredients may be widely varied in specific multiples of the liquid removal composition, i.e., more dilute or more concentrated, in the broad practice of the invention, and it will be appreciated that the liquid removal compositions of the invention can variously and alternatively comprise, consist or consist essentially of any combination of ingredients consistent with the disclosure herein.

Accordingly, another aspect of the invention relates to a kit including, in one or more containers, one or more components adapted to form the compositions of the invention. Preferably, the kit includes, in one or more containers, at least one organic solvent, at least one etchant, optionally at least one surfactant, optionally at least one amine, optionally water, and optionally corrosion inhibitor, for immediate use at the fab or the point of use. Alternatively, the kit may include, in one or more containers, at least one organic solvent, at least one etchant, optionally at least one surfactant, optionally at least one amine, and optionally corrosion inhibitor, for combining with water at the fab or the point of use. In another alternative, the kit includes, in one or more containers, at least one organic solvent, at least one etchant, optionally at least one surfactant, optionally at least one amine, optionally water, and optionally corrosion inhibitor, for combining with organic solvent and/or water at the fab or the point of use. The containers of the kit must be suitable for storing and shipping said removal compositions, for example, NOWPak® containers (Advanced Technology Materials, Inc., Danbury, Conn., USA). The one or more containers which contain the components of the removal composition preferably include means for bringing the components in said one or more containers in fluid communication for blending and dispense. For example, referring to the NOWPak® containers, gas pressure may be applied to the outside of a liner in said one or more containers to cause at least a portion of the contents of the liner to be discharged and hence enable fluid communication for blending and dispense. Alternatively, gas pressure may be applied to the head space of a conventional pressurizable container or a pump may be used to enable fluid communication. In addition, the system preferably includes a dispensing port for dispensing the blended removal composition to a process tool.

Substantially chemically inert, impurity-free, flexible and resilient polymeric film materials, such as high density polyethylene, are preferably used to fabricate the liners for said one or more containers. Desirable liner materials are processed without requiring co-extrusion or barrier layers, and without any pigments, UV inhibitors, or processing agents that may adversely affect the purity requirements for components to be disposed in the liner. A listing of desirable liner materials include films comprising virgin (additive-free) polyethylene, virgin polytetrafluoroethylene (PTFE), polypropylene, polyurethane, polyvinylidene chloride, polyvinylchloride, polyacetal, polystyrene, polyacrylonitrile, polybutylene, and so on. Preferred thicknesses of such liner materials are in a range from about 5 mils (0.005 inch) to about 30 mils (0.030 inch), as for example a thickness of 20 mils (0.020 inch).

Regarding the containers for the kits of the invention, the disclosures of the following patents and patent applications are hereby incorporated herein by reference in their respective entireties: U.S. Pat. No. 7,188,644 entitled “APPARATUS AND METHOD FOR MINIMIZING THE GENERATION OF PARTICLES IN ULTRAPURE LIQUIDS;” U.S. Pat. No. 6,698,619 entitled “RETURNABLE AND REUSABLE, BAG-IN-DRUM FLUID STORAGE AND DISPENSING CONTAINER SYSTEM;” and U.S. Patent Application No. 60/916,966 entitled “SYSTEMS AND METHODS FOR MATERIAL BLENDING AND DISTRIBUTION” filed on May 9, 2007 in the name of John E. Q. Hughes.

As applied to microelectronic device manufacturing operations, the liquid removal compositions of the present invention are usefully employed to remove silicon-containing insulating materials including, but not limited to, silicon oxide, P-TEOS, TEOS, BPSG, PEOX, HDP, PSG, SOD, thermal oxide, updoped silicate glass, sacrificial oxides, silicon-containing organic polymers, silicon-containing hybrid organic/inorganic materials, OSG, FSG, HSQ, CDO, and combinations thereof, from the surface of the microelectronic device. Importantly, the liquid removal compositions of the invention do not substantially damage the lower electrode, e.g., TiN, the device substrate, and/or the etch stop layer materials, e.g., SiN, also present on the microelectronic device. Of particular importance, the liquid removal compositions of the invention selectively remove silicon-containing oxides without substantially etching silicon and other metal nitrides. Preferably the liquid removal compositions remove at least 85% of the silicon-containing materials present on the device to be removed, more preferably at least 90%, even more preferably at least 95%, and most preferably at least 99% of the silicon-containing materials to be removed are removed from the surface of the microelectronic device.

In yet another aspect, the invention relates to dense removal compositions including dense fluids, e.g., supercritical fluids (SCF), as the primary solvent system. Because of its readily manufactured character and its lack of toxicity and negligible environmental effects, supercritical carbon dioxide (SCCO₂) is the preferred SCF. SCCO₂ is an attractive reagent for removal of microelectronic device process contaminants, since SCCO₂ has the characteristics of both a liquid and a gas. Like a gas, it diffuses rapidly, has low viscosity, near-zero surface tension, and penetrates easily into deep trenches and vias. Like a liquid, it has bulk flow capability as a “wash” medium. SCCO₂ has a density comparable to organic solvents and also has the advantage of being recyclable, thus minimizing waste storage and disposal requirements.

The dense removal composition according to one embodiment comprises dense CO₂ and the liquid removal composition, i.e., a liquid concentrate, in the following ranges, based on the total weight of the composition:

| component of | % by weight |
|---|---|
| dense CO₂ | about 70.0% to about |
| | 99.99% |
| liquid removal composition | about 0.01% to about 30.0% |

where the liquid removal composition comprises about 0.1 wt. % to about 98 wt. % organic solvent(s), about 0.1 wt. % to about 20 wt. % etchant(s), optionally 0 to about 10 wt. % surfactant(s), optionally 0 to about 10 wt. % amine(s), optionally 0 to about 10 wt. % water, and optionally 0 to about 5 wt. % corrosion inhibitor, based on the total weight of the composition, wherein the organic solvent(s), etchant(s), optional surfactant(s), optional amine(s), and optional corrosion inhibitor(s) contemplated include the aforementioned species.

In one aspect, the range of mole ratios of liquid removal composition relative to SCCO₂ in the dense removal composition is about 1:200 to about 1:4, more preferably about 1:100 to about 1:3.

In the broad practice of the invention, the dense removal composition may comprise, consist of, or consist essentially of SCCO₂ and the liquid removal composition, i.e., at least one organic solvent, at least one etchant, optionally at least one surfactant, optionally at least one amine, optionally water, and optionally corrosion inhibitor. In general, the specific proportions and amounts of SCCO₂ and liquid removal composition, in relation to each other, may be suitably varied to provide the desired removal action of the dense removal composition for the silicon-containing material and/or processing equipment, as readily determinable within the skill of the art without undue effort. Importantly, the liquid removal composition may be at least partially dissolved and/or suspended within the dense fluid of the dense removal composition.

In yet another embodiment, the invention relates to a dense removal composition useful in removing silicon-containing material from a microelectronic device as described herein, wherein the dense removal composition further includes insulating material, wherein the insulating material comprises a silicon-containing compound. Importantly, the insulating material may be dissolved and/or suspended in the dense removal composition of the invention.

As applied to microelectronic manufacturing operations, the dense removal compositions of the present invention are usefully employed to remove silicon-containing materials including, but not limited to, silicon oxide, P-TEOS, TEOS, BPSG, PEOX, HDP, PSG, SOD, thermal oxide, updoped silicate glass, sacrificial oxides, silicon-containing organic polymers, silicon-containing hybrid organic/inorganic materials, OSG, FSG, HSQ, CDO, and combinations thereof, from the surface of the microelectronic device. Importantly, the dense removal compositions of the invention do not substantially damage the lower electrode, the device substrate, and/or the etch stop layer materials which may also present on the microelectronic device. Preferably the dense removal compositions remove at least 85% of the silicon-containing materials present on the device to be removed, more preferably at least 90%, even more preferably at least 95%, and most preferably at least 99% of the silicon-containing materials to be removed are removed from the surface of the microelectronic device.

In yet another aspect, the invention relates to methods of removal of silicon-containing materials including, but not limited to, silicon oxide, P-TEOS, TEOS, BPSG, PEOX, HDP, PSG, SOD, thermal oxide, updoped silicate glass, sacrificial oxides, silicon-containing organic polymers, silicon-containing hybrid organic/inorganic materials, OSG, FSG, HSG, CDO, and combinations thereof, from a microelectronic device using the liquid or dense liquid compositions described herein. Importantly, the liquid removal compositions are intended for use in the non-supercritical state, while the dense removal compositions, i.e., liquid removal compositions diluted in a dense fluid, are intended for use in the supercritical or subcritical state. For example, sacrificial and/or capping insulating layers may be cleaned while maintaining the integrity of the lower electrode, the device substrate and/or the etch stop layer materials also present on the microelectronic device. It should be appreciated by one skilled in the art that the compositions described herein may be used in a one-step or multi-step removal process. An important aspect of the present invention is the selectivity of the removal compositions for silicon-containing oxide species relative to materials of the lower electrode, the device substrate and/or the etch stop layer. For example, preferably the selectivity of the removal compositions for P-TEOS relative to SiN is in a range from about 3:1 to about 100:1, more preferably about 10:1 to about 40:1, and the selectivity of the removal compositions for BPSG relative to SiN is in a range from about 5:1 to about 400:1, more preferably about 15:1 to about 200:1.

The liquid removal compositions of the present invention are readily formulated by simple mixing of ingredients, e.g., in a mixing vessel or the cleaning vessel under gentle agitation. The dense removal compositions are readily formulated by static or dynamic mixing at the appropriate temperature and pressure for the appropriate amount of time.

In the removal application, the liquid removal composition is applied in any suitable manner to the microelectronic device having silicon-containing material thereon, e.g., by spraying the composition on the surface of the device, by dipping (in a volume of the composition) of the device including the silicon-containing material, by contacting the device with another material, e.g., a pad, or fibrous sorbent applicator element, that has the composition absorbed thereon, by contacting the device including the silicon-containing material with a circulating composition, or by any other suitable means, manner or technique, by which the liquid removal composition is brought into contact with the silicon-containing material on the microelectronic device. The removal application may be static and/or dynamic, as readily determined by one skilled in the art. Preferably, the removal application is static in nature because of the high aspect ratio of the features and the propensity for collapse. Moreover, the process may be for a batch or single wafer system.

In use of the compositions of the invention for removing silicon-containing layers from microelectronic devices having same thereon, the liquid removal composition typically is contacted with the device for a time of from about 1 min to about 60 minutes, preferably about 5 min to 30 min, at temperature in a range of from about 20° C. to about 150° C., preferably about 60-80° C. Such contacting times and temperatures are illustrative, and any other suitable time and temperature conditions may be employed that are efficacious to at least partially remove the insulating layers from the device, within the broad practice of the invention. “At least partially remove” corresponds to at removal of at least 90% of the silicon-containing material present on the device prior to removal as described herein, more preferably at least 95%, and most preferably at least 99%.

Following the achievement of the desired cleaning action, the liquid removal composition may be readily removed, e.g., rinsed, from the device to which it has previously been applied, as may be desired and efficacious in a given end use application of the compositions of the present invention. For example, the device may be rinsed with methanol, isopropanol, ethylene glycol, water, a water/surfactant mixture, or combinations thereof. Thereafter, the device may be dried using nitrogen, a spin-dry cycle, or vapor-dry. Specific rinsing processes include: (i) rinse/dip with methanol, then rinse/dip with isopropanol, then dry; (ii) rinse/dip with ethylene glycol, rinse/dip with isopropanol, then dry; (iii) rinse/dip with isopropanol, then dry; (iv) rinse/dip with a water/surfactant mixture (99.96 wt. % water/0.04 wt. % ZONYL® FSO-100: surface tension=18.5±0.5 dynes cm¹ at 22° C. and 19.7±0.5 dynes cm⁻¹ at 20° C.), rinse/dip with isopropanol, then dry; (v) rinse/dip with methanol at room temperature (20-26° C.), then rinse/dip with hot IPA (50-60° C.), then dry; (vi) rinse/dip in water/surfactant mixture (99.96 wt. % water/0.04 wt. % ZONYL® FSO-100) at room temperature (20-26° C.), then rinse/dip with hot IPA (50-60° C.), then dry; (vii) rinse/dip in water/surfactant mixture (99.96 wt. % water/0.04 wt. % ZONYL® FSO-100) at 50-60° C., then rinse/dip with hot IPA (50-60° C.), then dry; (viii) rinse/dip in water/surfactant mixture (99.96 wt. % water/0.04 wt. % ZONYL® FSO-100) at 60-75° C., then rinse/dip with hot IPA (60-75° C.), then dry; or (ix) rinse/dip in water/IPA/surfactant mixture (49.75 wt. % water/49.75 wt. % IPA/0.50 wt. % ZONYL®K FSO-100: surface tension=20.9±0.3 dynes cm⁻¹ at 20° C.) at 60-75° C., then rinse/dip with hot IPA (60-75° C.), then dry. Preferably, the rinsing scheme comprises option (viii). Regardless of the rinsing method chosen, the inventors discovered that rinsing with methanol or a water/surfactant mixture followed by an IPA rinse removes surface residues. An IPA rinse alone is not enough to completely remove surface residues. Furthermore, preferably the first rinsing solution includes surfactant to reduce the surface tension of the rinsing composition and minimize (preferably eliminate) feature collapse. The preferred surfactant for the first rinsing composition is ZONYL® FSO-100. Importantly, the higher the temperature of the rinsing solution, the lower the surface tension with a concomitant reduction in feature leaning.

For removal applications using the dense removal compositions, the microelectronic device surface having the silicon-containing layers thereon is contacted with the dense removal composition, at suitable elevated pressures, e.g., in a pressurized contacting chamber to which the dense removal composition is supplied at suitable volumetric rate and amount to effect the desired contacting operation, for at least partial removal of the silicon-containing layers from the microelectronic device surface. The chamber may be a batch or single wafer chamber, for continuous, pulsed or static cleaning, preferably static cleaning because of the high aspect ratio of the features and the propensity for collapse. The removal of the silicon-containing layers by the dense removal composition may be enhanced by use of elevated temperature and/or pressure conditions during contacting of the silicon-containing layers with the dense removal composition.

The appropriate dense removal composition may be employed to contact a microelectronic device surface having silicon-containing layers thereon at a pressure in a range of from about 800 to about 6,000 psi, preferably about 2,400 to about 3,000 psi, for sufficient time to effect the desired removal of the silicon-containing layers, e.g., for a contacting time in a range of from about 1 minute to about 60 minutes, preferably about 4 min to about 30 min, and a temperature of from about 20° C. to about 100° C., preferably about 35° C. to about 70° C., although greater or lesser contacting durations and temperatures may be advantageously employed in the broad practice of the present invention.

The removal process using the dense removal composition may include a static soak, a dynamic cleaning mode, or sequential processing steps including dynamic flow of the dense removal composition over the microelectronic device surface, followed by a static soak of the device in the dense removal composition (or vice versa), with the respective dynamic flow and static soak steps being carried out alternatingly and repetitively, in a cycle of such alternating steps.

A “dynamic” contacting mode involves continuous flow of the composition over the device surface, to maximize the mass transfer gradient and effect complete removal of the silicon-containing layers from the surface. A “static soak” contacting mode involves contacting the device surface with a static volume of the composition, and maintaining contact therewith for a continued (soaking) period of time.

Following the contacting of the dense removal composition to the microelectronic device surface, the device thereafter preferably is washed with rinsing solution, for example, water, methanol, isopropanol, water/surfactant mixture (99.96 wt. % water/0.04 wt. % ZONYL® FSO-100), or combinations thereof, to remove any residual precipitated chemical additives from the region of the device surface in which silicon-containing layer removal has been effected. Specific rinsing processes include: rinse (dip) in methanol, then rinse (dip) into isopropanol, then dry; rinse with methanol, rinse with isopropanol, then dry; and dip into methanol, dip into water, dip into methanol, rinse with methanol, rinse with isopropanol, then dry. All of these solutions may be maintained at temperatures ranging from room temperature to 100° C.

It will be appreciated that specific contacting conditions for the liquid removal and the dense removal compositions of the invention are readily determinable within the skill of the art, based on the disclosure herein, and that the specific proportions of ingredients and concentrations of ingredients in the compositions of the invention may be widely varied while achieving desired removal of the silicon-containing materials on the microelectronic device surface.

Yet another aspect of the invention relates to the improved microelectronic devices made according to the methods of the invention and to products containing such microelectronic devices.

A still further aspect of the invention relates to methods of manufacturing an article comprising a microelectronic device, said method comprising contacting the microelectronic device with a removal composition for sufficient time to remove silicon-containing materials, including silicon-containing insulating layers, from the microelectronic device having said silicon-containing materials thereon, and incorporating said microelectronic device into said article, wherein the removal composition includes at least one organic solvent, at least one etchant, optionally at least one surfactant, optionally at least one amine, optionally water, and optionally corrosion inhibitor.

Removal compositions may be monitored and controlled using statistical process controls (SPC) during contact of the compositions with the microelectronic device wafers. For example, the SPC of the removal composition bath may be monitored and several inputs controlled, including temperature of the bath, concentration of the major components of the bath, concentration of the byproducts, and feed chemical purity. Preferably, the removal composition is monitored using in-line monitoring, wherein in-line sampling equipment may be communicatively coupled with standard analytical tools to monitor bath weight loss (which is an indication of solvent and/or amine loss), fluoride concentration, surface tension, etc. By monitoring and/or controlling at least one of these parameters, the life of the removal composition bath may be extended, which maximizes process efficiency. The purpose of the SPC is to maintain a substantial steady state of several parameters of the removal composition as processing occurs over time, as readily determined by one skilled in the art.

For example, the removal composition may be sampled, manually and/or automatically, and the concentration of a component in the removal composition may be analyzed, using standard analytical techniques, and compared to the initial concentration of said component in the removal composition. An aliquot of a solution of said component may be added, either manually and/or automatically, to the bath to boost the concentration of the component to initial levels, as readily determined by one skilled in the art. It should be appreciated that the maintenance of the concentration of several components in the removal composition is dependent on how much loading of material(s) to be removed has occurred in said composition. As more and more compounds are dissolved therein, the solubility of many active components will actually decrease and eventually fresh removal composition will be required.

Towards this end, the SPC invention relates in one aspect to a multicomponent fluid composition monitoring and compositional control system, in which a component analysis is effected by titration or other analytical procedure, for one or more components of interest, and a computational means then is employed to determine and responsively adjust the relative amount or proportion of the one or more components in the multicomponent fluid composition, in order to maintain a predetermined compositional character of the multicomponent fluid composition. The SPC system preferably comprises (i) an analyzer unit, constructed and arranged to monitor the concentration of one or more components of the multicomponent fluid using a real-time methodology, and (ii) a control unit constructed and arranged to compare the results of the analyzer unit to pre-programmed specifications and responsively control dispensing of the aforementioned one or more components into the multicomponent fluid as required to maintain a predetermined concentration of the aforementioned one or more components in the multicomponent fluid used in the fluid-using processing facility. In another aspect, the invention relates to an SPC process of monitoring and compositionally controlling a multicomponent fluid used in a processing facility, such process including conducting a real-time component analysis of the multicomponent fluid by titration or other analytical procedure, for one or more components of interest, and computationally and responsively adjusting in real time the relative amount or proportion of the one or more components in the multicomponent fluid composition, to maintain a predetermined compositional character of the multicomponent fluid composition utilized in the fluid-using processing facility.

As another example, the control unit functions as a process controller and is used to accurately control the automatic replenishment of the solvent components, guaranteeing optimum and stable processing over an extended period of time. Once the component analyzer determines the relative composition of the solvent system, the process controller can restore the system to the correct component ratio. Specific limits are pre-programmed into the process controller for the specific component(s) being targeted for analysis. The results from the component analyzer are compared to these specification limits and, if determined to be below the minimum specification value, amounts of the target component can be injected into the solvent solution to restore the required component ratio. By maintaining the component ratio of the solvent system within predetermined limits, the effective bath life of the solvent mixture can be extended. For example, the amount of organic solvent, the amount of surfactant, the amount of etchant, and the surface tension of the composition may be monitored and adjusted.

These and other SPC embodiments are disclosed in U.S. Pat. Nos. 7,214,537 and 7,153,690, both in the name of Russell Stevens, et al., and both of which are hereby incorporated by reference in their entirety.

With regards to the analysis of HF in a removal composition of the invention, the analyzer unit of the SPC may include: (a) a combination of temperature, electrical conductivity, viscosity and ultrasonic propagation velocity values may be analyzed and used to calculate the concentration of HF (see, e.g., U.S. Pat. No. 6,350,426 in the name of Sota et al.); (b) fluoride ion-selective electrodes; (c) spectrophotometry; (d) calorimetrically using boronic acid chemistry; and (e) spectrofluorometrically using boronic acid fluorophores (see, e.g., PCT/US2004/022717 filed Jun. 28, 2004 in the name of University of Maryland Biotechnology Institute); to determine the concentration of fluoride in the removal composition. The water content of the removal composition may be analyzed using the Karl Fischer process.

Analysis units of the invention may include, but are not limited to, UV-Vis spectrophotometers, IR spectrometers, near IR spectrometers, fluorometers, atomic spectrometers including inductively coupled plasma spectrometers and atomic absorption spectrometers, titration units, electrochemical units and chromatographic units.

The present invention further relates to methods of using external visible indicators to identify the endpoints of the removal composition bath

Towards this end, the external indicators may be a strip including colorants and an organic binder, wherein the strip material and the organic binder do not chemically react with the removal compositions of the invention, the microelectronic devices, or the colorant material. The colorants may include, but are not limited to, Methylene violet, Lissamine green B, Alkali blue 6 B, Malachite green oxalate, Toluidine blue O, Brilliant green, or combinations thereof. The organic binder may be selected from synthetic or natural polymers or resins, including but not limited to, cellulose acetate butyrate, ethyl cellulose, ethyl cellulose, acrylic resins, shellac, and combinations thereof. The strip substrate may include, but is not limited to, polymer materials, such as polyester, polyethylene, or polystyrene films, papers, and the like. Another aspect of the invention relates to a kit including indicator strips, a color chart, and conversion charts to assist the user in quickly determining how much removal composition component should be added to the removal composition based on the color change. Importantly, the indicator strips may be reusable or designed for one-time use. It should be appreciated that an ultraviolet radiation indicator may be used in place of the visible indicator, wherein all changes are monitored by a UV-VIS spectrophotometer or equivalent thereof.

In still another aspect, a variation of the indicator teaching includes including a visible indicator in the removal composition of the invention, wherein the visible indicator changes from one color to another when the removal composition is no longer efficacious for the removal of materials (e.g., silicon-containing materials) from the microelectronic device, e.g., the bath endpoint. For example, the visible indicator may be present in the one or more containers of a removal composition kit whereby upon mixing the indicator is activated. Alternatively, the indicator may be manufactured separately as a solid or a liquid that is added to the removal composition prior to or during removal application. In yet another alternative, the indicator may be included in one or more containers of a removal composition kit and the indicator is already active. When the composition has reached its endpoint, the indicator will undergo the transition from one “color” to another “color.” It is to be appreciated that the transition may be from colorless to a color in the visible spectrum, from a color in the visible spectrum to another color in the visible spectrum, or from a color in the visible spectrum to colorless. The indicator may be a dye additive, for example, Malachite green oxalate, Crystal violet, Methyl violet 2B, Ethyl violet, New fuchsin, Victoria blue B, Victoria pure blue BO, Toluidine blue O, Luxol brilliant green BL, Disperse blue 1, Brilliant blue R, Victoria R, Quinea green B, Thionin, Meldolas blue, Methylene green, Lissamine green B, Alkali blue 6B, Brilliant green, Spirit soluble HLK BASF, Victoria green S extra, Acid violet 17, Eriochrome black T, Eriochrome blue black B, D & C green no. 2, Spirit soluble fast RR, Spirit soluble fast red 3B, D & C red no. 22, Nitro red, Congo red, Cresol red, Brilliant cresyl blue ALD, Arsenazo 1, Basic red 29, Bismarck brown R, Methylene violet, Methylene violet 3RAX, Mordant brown 1, Reactive black 5, Mordant brown 48, Acid brown AX987, Acid violet AX990, Basic red 15, Mordant red 19, Bromopyrogallol red, and combinations thereof. Various combinations of these dyes can be used in the indicator compositions of the present invention.

In another aspect, the present invention further relates to a process of to minimizing evaporation of the removal composition over time by including a layer of material(s) on the bath to minimize evaporative effects. Notably, the layer has to include a material or materials that will not substantially dissolve or intermingle in the compositions of the bath. For example, TEFLON® coated materials or TEFLON® materials that float on the surface of the bath, i.e., are less dense than the bath, may be used to completely cover the bath and slow evaporation, thereby increasing the bath life. TEFLON® coated materials may include hollow, lightweight shapes such as spheres and other polygonal shapes. The shapes may be symmetrical or unsymmetrical. Alternatively, the TEFLON® coated materials may be a shape that is designed to easily fit over the bath, e.g., a floating lid.

Following processing, the compositions of the invention may be further processed to lower the chemical oxygen demand (COD) of the waste water stream in the fabrication facility. For example, mixed aqueous-organic formulations containing both organic solvents and inorganic biotoxic compounds such as fluorides may be treated with (1) carbon, preferably a polyvinylidene chloride (PVDC) monolith carbon having micropores less than 1 nm wide, which will “scrub” the organic solvent from the composition, (2) a metal carbonate, such as alkali or alkaline earth metal carbonate, which can react with the fluoride ions and neutralize any acid present, and/or (3) a calcium silicate, such as Ca₃SiO₅.Ca₂SiO₄.xH₂O, which can react with the fluoride ions and neutralize any acid present. The treatments may be sequential or in a one-step mixed bed approach. The waste water stream of the fab should be exposed to the treatment(s) until the COD is lowered to promulgated acceptable levels.

The removal compositions described herein have advantages over current processes of record due to the relatively low surface tensions and moderate oxide:SiN selectivities of the subject compositions. In addition, these formulations substantially dissolve fluorosilicate species, and the water/surfactant or methanol rinsing compositions (also very low surface tensions) dissolve any remaining/trace residues. It is also important to note that feature leaning is observed with higher surface tension formulations (i.e., surface tension≧28 dyne/cm@20° C.) and due to the low surface tension of the removal compositions of the invention, feature leaning is substantially eliminated. As such, the removal compositions and rinsing solutions are formulated to have surface tension in a range from about 12 dynes cm⁻¹ to about 30 dynes cm⁻¹, preferably about 16 dynes cm⁻¹ to about 25 dynes cm⁻¹. Furthermore, the higher the temperature of the removal compositions and rinsing solutions, the lower the surface tension of said liquid with a concomitant reduction in feature leaning.

The features and advantages of the invention are more fully illustrated by the following non-limiting examples, wherein all parts and percentages are by weight, unless otherwise expressly stated.

### Example 1

Blanketed P-TEOS, BPSG and SiN wafers were processed at various temperatures with 2.5 mL, 5 mL or 9 mL of Formulations A-I in SCCO₂ (to form the SCCO₂ removal composition) in an approximately 100 mL cleaning chamber for 1 min at various pressures using a dynamic system. In the present case, the dynamic system included the pressurization of the cleaning chamber to the indicated pressure and the subsequent introduction of the indicated formulation into the chamber with constant stirring (at 960 rpm) of the SCCO₂ removal composition therein. Following processing, the chamber was slowly depressurized through a back pressure regulator. The processed wafers were subsequently rinsed with methanol and isopropanol and then dried under nitrogen. The results are shown in Table 1 below.

TABLE 1
Etch rates of blanketed wafers in SCCO₂ removal composition.

| | | P-TEOS | | SiN |
|---|---|---|---|---|
| | | etch | BPSG etch | etch |
| | | rate/ | rate/ | rate/ |
| Formulation | Conditions | Å min⁻¹ | Å min⁻¹ | Å min⁻¹ |
| A | 35° C., 180 bar, 9 mL | 5306 | 3604 | 186 |
| A | 50° C., 180 bar, 9 mL | 9054 | 7794 | 476 |
| A | 60° C., 180 bar, 9 mL | 9200 | 8720 | 640 |
| B | 50° C., 180 bar, 9 mL | 8585 | 4576 | 466 |
| B | 50° C., 240 bar, 9 mL | 8900 | 4870 | 450 |
| B | 50° C., 195 bar, 6 mL | 4394 | 3925 | 257 |
| B | 40° C., 195 bar, 4.5 mL | 4309 | 2549 | 214 |
| C | 50° C., 230 bar, 9 mL | 4697 | 7549 | 426 |
| D | 50° C., 210 bar, 9 mL | 1356 | 2970 | 330 |
| D | 50° C., 200 bar, 5 mL | 760 | 2905 | 234 |
| E | 50° C., 185 bar, 9 mL | >4836 | 4218 | 563 |
| E | 35° C., 195 bar, 5 mL | 2394 | 4340 | 231 |
| E | 35° C., 180 bar, 2.5 mL | 1349 | 2039 | 178 |
| F | 70° C., 200 bar, 5 mL | 1327 | 1193 | 131 |
| G | 70° C., 185 bar, 9 mL | 2321 | 2161 | 195 |
| G | 70° C., 190 bar, 5 mL | 2309 | 2127 | 273 |
| G | 50° C., 210 bar, 5 mL | 1667 | >1758 | 93 |
| H | 70° C., 195 bar, 9 mL | 555 | 2199 | 154 |
| I | 70° C., 195 bar, 9 mL | >3200 | >3010 | 196 |

Importantly, the oxide removal occurred via an etching/dissolution process. It can be seen that the selectivities of the dense removal composition for the silicon-containing layers relative to the SiN layers range from about 3:1 to about 30:1, preferably from about 8:1 to about 30:1, depending on the conditions of the removal process and the formulation used.

### Example 2

Blanketed P-TEOS, BPSG and SiN wafers were processed at 60° C. with liquid Formulations I-R for 1 min using a static soak system. The processed wafers were subsequently rinsed with methanol and isopropanol and then dried under nitrogen. The results are shown in Table 2 below.

TABLE 2
Etch rates of blanketed wafers in liquid removal composition.

| | P-TEOS etch | BPSG etch | SiN etch |
|---|---|---|---|
| | rate/ | rate/ | rate/ |
| Formulation | Å min⁻¹ | Å min⁻¹ | Å min⁻¹ |
| I | 4122 | 3027 | 136 |
| J | 2027 | 1576 | 73 |
| K | 828 | 3384 | 87 |
| L | 4530 | 1151 | 123 |
| M | 4551 | 1000 | 97 |
| N | 2896 | 2003 | 114 |
| O | 2771 | 1862 | 102 |
| P | 2746 | 1906 | 110 |
| Q | 2834 | 2504 | 126 |
| R | 2808 | 2130 | 98 |

Importantly, the liquid removal compositions were very effective at removing the silicon-containing insulating layers without substantially etching the SiN etch stop material. For example, the etch rates of P-TEOS and BPSG were in a range from about 2000 Å min⁻¹ to about 4600 Å mind and about 1000 Å mind to about 3500 Å min¹, respectively, and the selectivity of P-TEOS and BPSG relative to SiN was in a range from about 20:1 to about 50:1 and about 10:1 to about 25:1, respectively, at 60° C. using the formulations of the invention.

With regards to the removal of insulating layers with Formulation I, followed by rinsing with methanol, isopropanol and drying, 98-100% of the P-TEOS and the BPSG were uniformly removed after 7-9 min of immersion at 60° C. The SiN and TiN were not attacked and no residues were observed on the surface.

With regards to the removal of insulating layers with Formulation J, followed by rinsing with methanol, isopropanol and drying, 85-90% of the P-TEOS and the BPSG were uniformly removed after 9 min of immersion at 60° C. The SiN and TiN were not attacked and no residues were observed on the surface.

With regards to the removal of insulating layers with Formulation K, followed by rinsing with methanol, isopropanol and drying, 90-95% of the P-TEOS and the BPSG were removed from some areas while only 40-50% were removed from other areas after 10 min of immersion at 60° C. The SiN and TiN were not attacked and no residues were observed on the surface.

With regards to the removal of insulating layers with Formulation L, followed by rinsing with methanol, isopropanol and drying, 85-90% of the P-TEOS and the BPSG were uniformly removed after 9 min of immersion at 60° C. The SiN and TiN were not attacked and no residues were observed on the surface. That said, 100% of the P-TEOS and the BPSG were uniformly removed after 13 min of immersion at 60° C., followed by rinsing with ethylene glycol, isopropanol, and drying. The SiN was slightly attacked, but the TiN was not attacked and no residues were observed on the surface.

With regards to the removal of insulating layers with Formulation M, followed by rinsing with ethylene glycol, isopropanol and drying, 100% of the P-TEOS and the BPSG were uniformly removed after 13 min of immersion at 60° C. The SiN and TiN were not attacked and no residues were observed on the surface.

With regards to the removal of insulating layers with Formulation N, followed by rinsing with isopropanol and drying, 98-99% of the P-TEOS and the BPSG were uniformly removed after 12 min of immersion at 60° C. The SiN and TiN were not attacked and residues were observed on the surface due to the rinse procedure.

With regards to the removal of insulating layers with Formulation 0, followed by rinsing with methanol, isopropanol and drying, −100% of the P-TEOS and the BPSG were uniformly removed after 12 min of immersion at 60° C. The SiN was slightly attacked, but the TiN was not attacked and no residues were observed on the surface.

With regards to the removal of insulating layers with Formulation P, followed by rinsing with a 99.96 wt. % water/0.04 wt. % ZONYL FSO-100 solution, isopropanol and drying, 100% of the P-TEOS and the BPSG were uniformly removed after 12 min of immersion at 60° C. The SiN was slightly attacked, but the TiN was not attacked and no residues were observed on the surface.

To summarize the results, propylene carbonate was an effective solvent for silicon oxide-containing insulating layer removal, amines increased the P-TEOS etch rates while simultaneously decreasing the BPSG etch rates, ethylene glycol in the formulation helps dissolve the fluorosilicate species, and rinsing with methanol, the water/surfactant mixture and/or ethylene glycol prior to an isopropanol rinse removes surface residue. Importantly, it is contemplated that any of formulations I-R may be combined with a dense fluid to form a dense removal composition for removal of insulating layers.

### Example 3

The sheet resistance of TiN films were determined before and after immersion in Formulations M-R for 1 min at 60° C. Sheet resistance was measured using a CDE ResMap four-point probe station. The results are summarized in Table 3 below. It can be seen that the formulations do not substantially alter the resistance of the lower electrode material which suggests that the TiN was not attacked by the formulations.

TABLE 3
Sheet Resistance of TiN films before and after processing with
Formulations M-R.

| | | Resistance |
|---|---|---|
| | Resistance before/ | after/ohms per |
| Formulation | ohms per square | square |
| M | 59.022 ± 0.4 | 58.862 ± 0.3 |
| N | 59.932 ± 0.4 | 59.624 ± 0.4 |
| O | 62.970 ± 0.3 | 63.086 ± 0.7 |
| P | 62.919 ± 0.6 | 62.794 ± 0.2 |
| Q | 61.321 ± 0.3 | 61.673 ± 0.7 |
| R | 64.781 ± 0.3 | 64.708 ± 0.3 |

### Example 4

Blanketed BPSG and SiN wafers were processed at 60° C. with liquid Formulations S-W for 1 min using a static soak system. The processed wafers were subsequently rinsed with methanol and isopropanol and then dried under nitrogen. The etch rate results are shown in Table 4 below. In addition, the sheet resistance of TiN films were determined before and after immersion in Formulations S-V for 1 min at 60° C. Sheet resistance was measured using a CDE ResMap four-point probe station. The sheet resistance results are summarized in Table 5 below.

TABLE 4
Etch rates of blanketed wafers in liquid removal composition.

| | BPSG etch rate/ | SiN etch rate/ | selectivity |
|---|---|---|---|
| Formulation | Å min⁻¹ | Å min⁻¹ | BPSG:SiN |
| S | 7931 | 55 | 144:1 |
| T | 7754 | 49 | 158:1 |
| U | 15868 | 76 | 209:1 |
| V | 1871 | 47 | 40:1 |
| W | 10492 | 52 | 202:1 |

TABLE 5
Sheet Resistance of TiN films before and after processing with
Formulations S-V.

| | Resistance before/ | Resistance after/ |
|---|---|---|
| Formulation | ohms per square | ohms per square |
| S | 64.100 ± 0.3 | 64.144 ± 0.4 |
| T | 62.753 ± 0.3 | 62.822 ± 0.3 |
| U | 62.690 ± 0.5 | 62.777 ± 0.6 |
| V | 63.244 ± 0.5 | 63.623 ± 0.5 |

It can be seen that the silicon-containing oxide insulating layer material is effectively removed (100% uniform removal) using formulations S-W and the SiN and TiN were not substantially attacked. Little or no residues remained on the wafers following processing. Importantly, it is contemplated that any of formulations S-W may be combined with a dense fluid to form a dense removal composition for removal of insulating layers.

### Example 5

The surface tension in dynes cm⁻¹ was determined at 20° C. for formulations AA-EE, II-KK, and MM-NN using a Krüss DSA10L2E drop shape analysis system. The results are reported in Table 6 below.

TABLE 6
Surface tension in dynes cm⁻¹ for formulations
AA-EE, II-KK, MM and NN.

| Formulation | surface tension/dynes cm⁻¹ |
|---|---|
| AA | 23.0 ± 0.5 |
| BB | 20.7 ± 1.0 |
| CC | 17.7 ± 0.6 |
| DD | 17.4 ± 0.1 |
| EE | 19.9 ± 0.1 |
| II | 24.0 ± 0.3 |
| JJ | 23.9 ± 0.1 |
| KK | 25.3 ± 0.1 |
| MM | 24.1 ± 0.1 |
| NN | 24.2 ± 0.1 |

### Example 6

Patterned wafers having exposed P-TEOS (approximately 9,000 Å thick), BPSG (approximately 9,000 Å thick), SiN and TiN and an aspect ratio of 13:1 were processed at 60° C. with liquid Formulations AA for 13-15.5 min using a static soak system. The wafers were subsequently rinsed.

After soaking for 13 minutes, and rinsing (rinse/dip with methanol at room temperature (20-26° C.), then rinse/dip with hot IPA (50-60° C.), then dry), it was observed that the P-TEOS was completely removed and the BPSG was 89-90% uniformly removed. The SiN and TiN were not attacked, no feature leaning was observed and no residue material was observed on the surface.

After soaking for 13 minutes, and rinsing (rinse/dip in water/surfactant mixture (99.96 wt. % water/0.04 wt. % ZONYL® FSO-100) at room temperature (20-26° C.), then rinse/dip with hot IPA (50-60° C.), then dry), it was observed that the P-TEOS was completely removed and the BPSG was 94-95% uniformly removed. The SiN and TiN were not attacked, no feature leaning was observed and no residue material was observed on the surface.

After soaking for 15 minutes, and rinsing (rinse/dip in water/surfactant mixture (99.96 wt. % water/0.04 wt. % ZONYL® FSO-100) at 50-60° C., then rinse/dip with hot IPA (50-60° C.), then dry), it was observed that the P-TEOS was completely removed and the BPSG was 97% uniformly removed. The SiN and TiN were not attacked, little or no feature leaning was observed and no residue material was observed on the surface.

After soaking for 15.5 minutes, and rinsing (rinse/dip in water/surfactant mixture (99.96 wt. % water/0.04 wt. % ZONYL® FSO-100) at 50-60° C., then rinse/dip with hot IPA (50-60° C.), then dry), it was observed that both the P-TEOS and BPSG were completely removed. The SiN and TiN were not attacked, little or no feature leaning was observed and no residue material was observed on the surface.

### Example 7

Patterned wafers having exposed P-TEOS (approximately 9,000 Å thick), BPSG (approximately 9,000 Å thick), SiN and TiN and an aspect ratio of 15:1 were processed at 60° C. with liquid Formulations CC for 11-12 min using a static soak system. The wafers were subsequently rinsed.

After soaking for 11 minutes, and rinsing (rinse/dip in water/surfactant mixture (99.96 wt. % water/0.04 wt. % ZONYL® FSO-100) at 60-75° C., then rinse/dip with hot IPA (60-75° C.), then dry), it was observed that the P-TEOS was completely removed and the BPSG was mostly removed (approximately 1650 Å remained). The SiN and TiN were not attacked, little or no feature leaning was observed and no residue material was observed on the surface.

After soaking for 12 minutes, and rinsing (rinse/dip in water/surfactant mixture (99.96 wt. % water/0.04 wt. % ZONYL® FSO-100) at 60-75° C., then rinse/dip with hot IPA (60-75° C.), then dry), it was observed that both the P-TEOS and BPSG were completely removed. The SiN and TiN were not attacked, some feature leaning was observed and no residue material was observed on the surface.

### Example 8

Patterned wafers having exposed P-TEOS (approximately 9,000 Å thick), BPSG (approximately 9,000 Å thick), SiN and TiN and an aspect ratio of 15:1 were processed at 70° C. with liquid Formulations JJ for 11-12 min using a static soak system. The wafers were subsequently rinsed.

After soaking for 11.5 minutes, and rinsing (rinse/dip in water/surfactant mixture (99.96 wt. % water/0.04 wt. % ZONYL® FSO-100) at 60-75° C., then rinse/dip with hot IPA (60-75° C.), then dry), it was observed that the P-TEOS was completely removed and the BPSG was mostly removed (approximately 1400 Å remained). The SiN and TiN were not attacked, little or no feature leaning was observed and no residue material was observed on the surface.

After soaking for 11.75 minutes, and rinsing (rinse/dip in water/surfactant mixture (99.96 wt. % water/0.04 wt. % ZONYL® FSO-100) at 60-75° C., then rinse/dip with hot IPA (60-75° C.), then dry), it was observed that both the P-TEOS and BPSG were completely removed. The SiN and TiN were not attacked, very little feature leaning was observed and no residue material was observed on the surface.

### Example 9

Patterned wafers having exposed P-TEOS (approximately 9,000 Å thick), BPSG (approximately 9,000 Å thick), SiN and TiN and an aspect ratio of 15:1 were processed at 70° C. with liquid Formulations KK for 9-10 min using a static soak system. The wafers were subsequently rinsed.

After soaking for 9 minutes, and rinsing (rinse/dip in water/surfactant mixture (99.96 wt. % water/0.04 wt. % ZONYL® FSO-100) at 60-75° C., then rinse/dip with hot IPA (60-75° C.), then dry), it was observed that the P-TEOS was completely removed and the BPSG was mostly removed (approximately 2415 Å remained). The SiN and TiN were not attacked, no feature leaning was observed and no residue material was observed on the surface.

After soaking for 10 minutes, and rinsing (rinse/dip in water/surfactant mixture (99.96 wt. % water/0.04 wt. % ZONYL® FSO-100) at 60-75° C., then rinse/dip with hot IPA (60-75° C.), then dry), it was observed that the P-TEOS was completely removed and the BPSG was mostly removed (approximately 1900 Å remained). The SiN and TiN were not attacked, little feature leaning was observed and no residue material was observed on the surface.

### Example 10

Blanketed P-TEOS, BPSG, and SiN wafers were processed in formulations AA-LL using a static soak procedure at temperatures ranging from 28-70° C. Subsequent to processing, the wafers were rinsed with water and IPA at room temperature and then dried with N₂. The etch rates of P-TEOS, BPSG and SiN were determined, as shown in Table 7 below. In addition, the sheet resistance of TiN films were determined before and after immersion in Formulations AA, CC, HH, JJ, KK, MM and NN for 1 min at temperatures ranging from 50-70° C. Sheet resistance was measured using a CDE ResMap four-point probe station. The sheet resistance results are summarized in Table 8 below.

TABLE 7
Etch rates of blanketed wafers in liquid removal composition.

| | | P-TEOS etch | BPSG etch | |
|---|---|---|---|---|
| | Temperature/ | rate/ | rate/ | SiN etch rate/ |
| Formulation | ° C. | Å min⁻¹ | Å min⁻¹ | Å min⁻¹ |
| AA | 60 | 2082 | 1482 | 66.4 |
| BB | 60 | 2002 | 1246 | 70.6 |
| CC | 60 | 2131 | 1225 | 60.6 |
| DD | 70 | 1806 | 1550 | 143.6 |
| EE | 60 | 1196 | 1054 | 82.1 |
| FF | 60 | 6291 | 7845 | 379.2 |
| FF | 28 | 1303 | 1781 | 88.1 |
| GG | 60 | 2768 | 2059 | 140.3 |
| HH | 50 | 3040 | 3314 | 159.8 |
| II | 70 | 2838 | 3066 | 234.1 |
| JJ | 70 | 2816 | 2655 | 221.1 |
| KK | 70 | 2042 | 1993 | 189.7 |
| LL | 70 | 2133 | 2108 | 212.5 |
| MM | 70 | 2245 | 1644 | 155.4 |
| NN | 70 | 2156 | 1897 | 156.6 |

TABLE 8
Sheet Resistance of TiN films before and after processing.

| | | Resistance before/ | Resistance after/ |
|---|---|---|---|
| Formulation | Temperature/° C. | ohms per square | ohms per square |
| AA | 60 | 62.005 ± 0.5 | 62.146 ± 0.8 |
| CC | 60 | 62.763 ± 0.4 | 62.755 ± 0.3 |
| HH | 50 | 60.708 ± 0.5 | 60.698 ± 0.5 |
| JJ | 70 | 61.650 ± 0.3 | 61.816 ± 0.4 |
| KK | 70 | 62.126 ± 0.5 | 61.998 ± 0.3 |
| MM | 70 | 61.525 ± 0.5 | 61.329 ± 0.3 |
| NN | 70 | 60.819 ± 0.3 | 60.852 ± 0.8 |

Importantly, the liquid removal compositions were very effective at removing the silicon-containing insulating layers without substantially etching the SiN etch stop material. For example, the etch rates of P-TEOS and BPSG were in a range from about 2000 Å min⁻¹ to about 3000 Å min⁻¹ and about 1200 Å min⁻¹ to about 2100 Å min⁻¹, respectively, and the selectivity of P-TEOS and BPSG relative to SiN was in a range from about 20:1 to about 35:1 and about 15:1 to about 25:1, respectively, at 60° C. using the formulations of the invention. Further, the etch rates of P-TEOS and BPSG were in a range from about 2000 Å min⁻¹ to about 3000 Å min⁻¹ and about 1500 Å min⁻¹ to about 3100 Åmin⁻¹, respectively, and the selectivity of P-TEOS and BPSG relative to SiN was in a range from about 10:1 to about 20:1 and about 10:1 to about 15:1, respectively, at 70° C. using the formulations of the invention.

### Example 11

Patterned wafers having exposed P-TEOS (approximately 9,000 Å thick), BPSG (approximately 9,000 Å thick), SiN and TiN and an aspect ratio of 15:1 were processed at 70° C. with liquid Formulation NN for 13-14 min using a static soak system. The wafers were subsequently rinsed.

After soaking for 13 minutes, and rinsing (rinse/dip in water/surfactant mixture (rinse/dip in water/surfactant mixture (99.96 wt. % water/0.04 wt. % ZONYL® FSO-100) at 60-75° C., then rinse/dip with hot IPA (60-75° C.), then dry), it was observed that the P-TEOS was completely removed and the BPSG was mostly removed (approximately 3594 Å remained). The SiN and TiN were not attacked, no feature leaning was observed and no residue material was observed on the surface.

After soaking for 14 minutes, and rinsing (rinse/dip in water/surfactant mixture (rinse/dip in water/surfactant mixture (99.96 wt. % water/0.04 wt. % ZONYL® FSO-100) at 60-75° C., then rinse/dip with hot IPA (60-75° C.), then dry), it was observed that the P-TEOS was completely removed and the BPSG was mostly removed (approximately 910 Å remained). The SiN and TiN were not attacked, some feature leaning was observed and no residue material was observed on the surface.

Although the invention has been variously disclosed herein with reference to illustrative embodiments and features, it will be appreciated that the embodiments and features described hereinabove are not intended to limit the invention, and that other variations, modifications and other embodiments will suggest themselves to those of ordinary skill in the art, based on the disclosure herein. The invention therefore is to be broadly construed, as encompassing all such variations, modifications and alternative embodiments within the spirit and scope of the claims hereafter set forth.

What is claimed is:

1. A removal composition comprising at least one organic solvent, at least one etchant, optionally at least one surfactant, optionally at least one amine, optionally water, and optionally at least one corrosion inhibitor, wherein said removal composition is suitable for removing silicon-containing material from a microelectronic device having said material thereon.

2. The removal composition of claim 1, further comprising at least one additional component selected from the group consisting of water, at least one amine at least surfactant, at least one corrosion inhibitor, and combinations thereof.

3. The removal composition of claim 1, wherein the at least one etchant comprises a fluoride source.

4. The removal composition of claim 3, wherein at least one etchant comprises a species selected from the group consisting of hydrogen fluoride, fluorosilicic acid (H₂SiF₆); fluoroboric acid; tetrabuylammonium tetrafluoroborate (TBA-BF₄); ammonium fluorosilicate ((NH₄)₂SiF₆); tetramethylammonium hexafluorophosphate; ammonium fluoride, tetraalkylammonium fluoride, alkyl hydrogen fluoride, ammonium hydrogen bifluoride (NH₅F₂), dialkylammonium hydrogen fluoride, trialkylammonium hydrogen fluoride, trialkylammonium trihydrogen fluoride, pyridine-HF complex, dimethylpyridine-HF complex, 2-ethylpyridine-HF complex, 2-methoxypyridonde-HF complex, 2-picoline-HF complex, pyridine derivative-HF complex, piperidine-HF complex, piperazine-HF complex, triethylamine-HF complex, triethanolamine-HF complex, PMDETA-HF complex, diglycol amine-HF complex, monoethanolamine-HF complex, pyrrole-HF complex, isoxazole-HF complex, 1,2,4-triazole-HF complex, bipyridine-HF complex, pyrimidine-HF complex, pyrazine-HF complex, pyridazine-HF complex, quinoline-HF complex, isoquinoline-HF complex, indole-HF complex, imidazole-HF complex, ethylamine-HF complex, methylamine-HF complex, isobutylamine-HF complex, tert-butylamine-HF complex, tributylamine-HF complex, dipropylamine-HF complex, dimethylamine-HF complex, 1-methylimidazole-HF complex, diisopropylamine-HF complex, diisobutylamine-HF complex, aniline-HF complex, aniline derivative-HF complex, N-methylmorpholine-N-oxide (NMMO)-HF complex, trimethylamine-N-oxide-HF complex, triethylamine-N-oxide-HF complex, pyridine-N-oxide-HF complex, N-ethylmorpholine-N-oxide-HF complex, N-methylpyrrolidine-N-oxide-HF complex, N-ethylpyrrolidine-N-oxide-HF complex, xenon difluoride (XeF₂), and combinations thereof.

5. The removal composition of claim 1, wherein the at least one organic solvent comprises a species selected from the group consisting of alcohols, diols, triols, glycol ethers, carbonates, amides, alkanes, pyrrolidinones, formates, acetates, ketones, glycols, and combinations thereof.

6. The removal composition of claim 1, wherein the at least one organic solvent comprises a species selected from the group consisting of toluene, decane, hexane, hexanes, octane, xylenes, odorless mineral spirits (petroleum naphtha), mineral spirits (hydrotreated heavy naphtha), phenoxy-2-propanol, propriophenone, cyclohexane, perfluoro-1,2-dimethylcyclobutane, perfluoro-1,2-dimethylcyclohexane, and perfluorohexane(s), methanol, ethanol, 1-propanol, isopropanol, 1-butanol, 2-butanol, 3-methyl-1-butanol, allyl alcohol, pentanol, diols, triols, 2,2,3,3,4,4,5,5-octafluoro-1-pentanol, 1H, 1H,9H-perfluoro-1-nonanol, perfluoroheptanoic acid, 1H, 1H,7H-dodecafluoro-1-heptanol, perfluoropentanoic acid, 1H,1H,8H,8H-dodecafluoro-1,8-octanediol, 2,2,3,3,4,4,5,5-octafluoro-1,6-hexanediol, 5H-perfluoropentanoic acid, n-butyl heptafluorobutyrate, tetrahydrofuran (THF), N-methylpyrrolidinone (NMP), N-octylpyrrolidinone, N-phenylpyrrolidinone, methyl formate, ethyl formate, propyl formate, butyl formate, 2-butanone, 3-pentanone, dimethyl formamide (DMF), dimethylsulfoxide (DMSO), dimethyl sulfide, ethanethiol, tetramethylene sulfone (sulfolane), 3-chloro-1,2-propanediol, 3-chloro-1-propanethiol, 1-chloro-2-propanol, 2-chloro-1-propanol, 3-chloro-1-propanol, 3-bromo-1,2-propanediol, 1-bromo-2-propanol, 3-bromo-1-propanol, 3-iodo-1-propanol, 4-chloro-1-butanol, 2-chloroethanol, diethyl ether, ethyl lactate, ethyl acetate, propyl acetate, isobutyl acetate, methyl butanoate, ethyl butanoate, ethyl benzoate, acetonitrile, methyl isobutyl ketone, methyl ethyl ketone, methyl propyl ketone, acetone, ethylene glycol, propylene glycol, diethylene glycol monomethyl ether, triethylene glycol monomethyl ether, diethylene glycol monoethyl ether, triethylene glycol monoethyl ether, ethylene glycol monopropyl ether, ethylene glycol monobutyl ether, diethylene glycol monobutyl ether, triethylene glycol monobutyl ether, ethylene glycol monohexyl ether, diethylene glycol monohexyl ether, ethylene glycol phenyl ether, propylene glycol methyl ether, dipropylene glycol methyl ether, tripropylene glycol methyl ether, dipropylene glycol dimethyl ether, dipropylene glycol ethyl ether, propylene glycol n-propyl ether, dipropylene glycol n-propyl ether (DPGPE), tripropylene glycol n-propyl ether, propylene glycol n-butyl ether, dipropylene glycol n-butyl ether, tripropylene glycol n-butyl ether, propylene glycol phenyl ether), dioxane, butyrolactone, butylene carbonate, ethylene carbonate, propylene carbonate, acetic acid, trifluoroacetic acid, and combinations thereof.

7. The removal composition of claim 1, wherein at least one organic solvent is fluorinated and the amount of said fluorinated organic solvent is less than about 85 wt. %, based on the total weight of the composition.

8. The removal composition of claim 1, comprising at least one amine, wherein the at least one amine is selected from the group consisting of pyridine, 2-ethylpyridine, 2-methoxypyridine, 3-methoxypyridine, 2-picoline, pyridine derivatives, dimethylpyridine, piperidine, piperazine, triethylamine, triethanolamine, ethylamine, methylamine, isobutylamine, tert-butylamine, tributylamine, dipropylamine, dimethylamine, diglycol amine, pentamethyldiaminotriamine (PMDETA), monoethanolamine, pyrrole, isoxazole, 1,2,4-triazole, bipyridine, pyrimidine, pyrazine, pyridazine, quinoline, isoquinoline, indole, imidazole, N-methylmorpholine-N-oxide (NMMO), trimethylamine-N-oxide, triethylamine-N-oxide, pyridine-N-oxide, N-ethylmorpholine-N-oxide, N-methylpyrrolidine-N-oxide, N-ethylpyrrolidine-N-oxide, 1-methylimidazole, diisopropylamine, diisobutylamine, aniline, aniline derivatives, and combinations thereof.

9. The removal composition of claim 1, comprising at least one surfactant, wherein the at least one surfactant comprises at least one of a nonionic, anionic, cationic and zwitterionic surfactant.

10. The removal composition of claim 9, wherein the at least one surfactant comprises a species selected from the group consisting of fluoroalkyl surfactants, SURFONYL® 104, TRITON™ CF-21, ZONYL® UR, ZONYL® FSO-100, ZONYL® FSN-100, 3M™ Fluorad™ fluorosurfactants, MASURF® FS-710, MASURF® FS-780, dioctylsulfosuccinate salt, 2,3-dimercapto-1-propanesulfonic acid salt, dodecylbenzenesulfonic acid, polyethylene glycols, polypropylene glycols, polyethylene glycol ethers, polypropylene glycol ethers, carboxylic acid salts, R₁ benzene sulfonic acids (where the R₁ is a straight-chained or branched C₈ to C₁₈ alkyl group), polyacrylate polymers, dinonylphenyl polyoxyethylene, silicone polymers, modified silicone polymers, acetylenic diols, modified acetylenic diols, amphiphilic fluoropolymers, alkylammonium salts, modified alkylammonium salts, sodium dodecyl sulfate, aerosol-OT (AOT) and fluorinated analogues thereof, alkyl ammonium, perfluoropolyether surfactants, 2-sulfosuccinate salts, phosphate-based surfactants, sulfur-based surfactants, and acetoacetate based polymers, as well as combinations comprising at least one of the foregoing surfactants.

11. The removal composition of claim 1, further comprising silicon-containing material residue, wherein the silicon-containing material residue comprises species selected from the group consisting of silicon oxide, plasma enhanced tetraethyl orthosilicate (P-TEOS), borophosphosilicate glass (BPSG), plasma enhanced oxide (PEOX), high density plasma oxide (HDP), phosphosilicate glass (PSG), spin-on-dielectrics (SOD), thermal oxide, updoped silicate glass, sacrificial oxides, silicon-containing organic polymers, silicon-containing hybrid organic/inorganic materials, organosilicate glass (OSG), TEOS, fluorinated silicate glass (FSG), hemispherical grain (HSQ), carbon-doped oxide (CDO) glass, and combinations thereof.

12. The compositions of claim 1, comprising a combination of components selected from (a)-(h): (a) a fluoride, a carbonate solvent and a glycol solvent; (b) a fluoride, a carbonate solvent and water; (c) a fluoride, a carbonate solvent, a glycol solvent, and water; (d) a fluoride, a carbonate solvent, a glycol solvent, water, and an amine; (e) at least two organic solvents and at least one etchant, wherein at least one organic solvent is fluorinated, wherein the composition is substantially devoid of added water; (f) an amine:HF complex, at least one fluorinated organic solvent, and at least one C₁-C₆ alcohol, wherein the composition is substantially devoid of added water; (g) amine:HF complex, fluorinated organic solvent and an amine, wherein the composition is substantially devoid of added water; or (h) amine:HF complex, C₁-C₆ alcohol, and a non-ionic surfactant, where the removal composition is substantially devoid of added water.

13. The compositions of claim 1, comprising a combination of components selected from (a)-(h): (a) HF, propylene carbonate, and ethylene glycol; (b) HF, propylene carbonate and water; (c) HF, propylene carbonate, ethylene glycol, and water; (d) HF, propylene carbonate, ethylene glycol, water, and an imidazole; (e) pyridine:HF, 2,2,3,3,4,4,5,5-octafluoro-1-pentanol, 1-butanol, wherein the composition is substantially devoid of added water; (f) pyridine:HF, 2,2,3,3,4,4,5,5-octafluoro-1-pentanol, 3-methyl-1-butanol, wherein the composition is substantially devoid of added water; (g) 2,2,3,3,4,4,5,5-octafluoro-1-pentanol, pyridine:HF, 1-methylimidazole, wherein the composition is substantially devoid of added water; or (h) pyridine:HF, methanol, and ZONYL FSO-100, where the removal composition is substantially devoid of added water.

14. The removal composition of claim 1, wherein selectivity of P-TEOS material relative to SiN is in a range from about 20:1 to about 50:1 at 60° C. and the selectivity of BPSG material relative to SiN is in a range from about 10:1 to about 25:1 at 60° C.

15. The removal composition of claim 1, further comprising at least one corrosion inhibitor selected from the group consisting of nitrilotris(methylene)triphosphonic acid, 1-hydroxyethylidene-1,1-diphosphonic acid (HEDP), ethylenedinitrilotetra(methylene-phosphonic) acid (EDTMP), ascorbic acid, DL-methionine, Korantin® PP, dimethylglyoxime, pyrophosphoric acid, their salts, L-cysteine, and combinations thereof.

16. The removal composition of claim 1, further comprising at least one dense fluid.

17. A kit comprising, in one or more containers, one or more of the following reagents for forming a removal composition, said one or more reagents selected from the group consisting of at least one organic solvent, at least one etchant, optionally at least one surfactant, optionally at least one amine, and optionally water, and wherein the kit is adapted to form a removal composition suitable for removing silicon-containing material from a microelectronic device having said material thereon.

18. A method of removing silicon-containing layers from a microelectronic device having said layers thereon, said method comprising contacting the microelectronic device with a removal composition for sufficient time to at least partially remove said material from the microelectronic device, wherein the removal composition includes at least one organic solvent, at least one etchant, optionally at least one surfactant, optionally at least one amine, and optionally water.

19. The method of claim 18, wherein said contacting comprises conditions selected from the group consisting of: time of from about 1 minute to about 60 minutes; temperature in a range of from about 20° C. to about 150° C.; and combinations thereof.

20. The method of claim 18, wherein the removal composition further comprises at least one dense fluid.

21. The method of claim 18, further comprising rinsing the microelectronic device with a first rinsing composition at first rinsing conditions following contact with the removal composition, wherein the first rinsing composition comprises a component selected from the group consisting of water, methanol, isopropanol, ZONYL® FSO-100, and combinations thereof.

22. The method of claim 21, further comprising rinsing the microelectronic device with a second rinsing composition at second rinsing conditions following contact with the first rinsing composition.

23. The method of claim 22, further comprising drying the microelectronic device following contact with the second rinsing composition.
